(19) United States
(12) Patent Application Publication
(10) Pub. No.: US 2015/0119103 A1
(43) Pub. Date: Apr. 30, 2015

(54) Priority Management for Multiple Concurrently Active Technologies

(71) Applicant: QUALCOMM Incorporated, San Diego, CA (US)

(72) Inventors: Francis Ming-Meng NGAI, Louisville, CO (US); Reza Shahidi, San Diego, CA (US); Amit Mahajan, San Diego, CA (US); Sridhar Bandaru, Westminster, CO (US); Ashish Gaonekar, Boulder, CO (US); Jeffrey Niemann, Superior, CO (US); Henri Felix Begin, Lyons, CO (US); Ling Hang, San Diego, CA (US); Srikanth Chintala, Hyderabad (IN); Shivank Nayak, Hyderabad (IN)

(73) Assignee: QUALCOMM Incorporated, San Diego, CA (US)

(21) Appl. No.: 14/065,586

(22) Filed: Oct. 29, 2013

(51) Int. Cl. H04W 48/18; H04W 60/00

(52) U.S. Cl. CPC H04W 48/18; H04W 60/005; H04W 52/0277
USPC 455/552.1

(57) ABSTRACT

Methods, systems and devices for prioritizing communication technologies to allocate resources in a mobile device. The mobile device may employ a dual subscription, dual active (DSDA) configuration in which two subscriptions may be associated with concurrently active communications, such as voice or data calls. The mobile device may identify current states that indicate the type of communications associated with the subscriptions. In an embodiment, an applications processor within the mobile device may perform the state identifications. The mobile device may determine priorities of the concurrently active subscriptions based on the identified states. In an embodiment, the priorities may be determined by a modem processor within the mobile device. When the priorities are determined to be the same, the mobile device may perform a tiebreaker algorithm to further identify priorities. Based on the determined priorities, the mobile device may allocate resources to favor the subscription with the higher priority.

### BACKGROUND

Mobile devices can now be configured to utilize more than one technology or subscription to provide concurrent voice and/or data services to users. Often, a multiple subscription mobile device may include a subscriber identification module (i.e., SIM or SIM card) for each subscription to enable data exchanges with different access networks. For example, the mobile device may use one subscription for receiving phone calls from an access network within a home country and another subscription for receiving phone calls from an access network while in a foreign country. Multiple subscriptions may also enable the mobile device to have simultaneous accounts active at a given time (e.g., subscriptions corresponding to two different cellular providers). In particular, the mobile device may utilize a dual subscription, dual active (or “DSDA”) configuration that employs two subscriptions to simultaneously exchange data with their respective access networks and/or accounts. For example, a mobile device utilizing a DSDA configuration may initiate an active telephonic phone call on a first subscription associated with a first network, switch over to a second subscription associated with a second network, and initiate another active phone call on the second network.

However, with simultaneous communication abilities in a multi-subscription configuration, mobile devices may experience suboptimal performance due to overly taxed device resources. In many cases, a DSDA configuration may cause a mobile device to drain battery service life quickly, have poor management of thermal mitigation, or experience an unsatisfactory user experience when multiple subscription communications are active. For example, a voice call on one subscription may experience lag or decreased quality of service when a concurrent data transfer is active on another subscription. As another example, a technology associated with a subscription may not be able to transmit at maximum transmit power due to constraints in specific absorption rate regulatory limits (e.g., “SAR”) and/or battery current.

### SUMMARY

The various embodiments provide devices and methods for prioritizing subscriptions to allocate resources in a mobile device employing a dual subscription, dual active configuration. When multiple subscriptions are active concurrently, such as when there is a data transfer and a voice call occurring at the same time, the mobile device may determine when resources need to be allocated in favor of a single subscription based on the type of information transmitted on that subscription. The mobile device may be configured to perform operations to identify states related to concurrently active subscriptions. In an embodiment, the mobile device may evaluate user inputs, such as detected graphical user interface button presses (e.g., “send”, etc.) as well as other events when identifying the states of subscriptions. With states of the subscriptions identified, the mobile device may determine the priorities of the subscriptions. In particular, the mobile device may determine the active subscription that has a higher priority (i.e., relative priorities). Based on the determined priorities, the mobile device may allocate resources to benefit the higher priority subscription.

In various embodiments, the mobile device may utilize an applications processor to identify the states of concurrently active subscriptions. As it may execute a high-level operating system, the applications processor may access information that indicates whether subscriptions correspond to voice calls, calls on local hold, or data calls, as well as other states and/or characteristics. Further, the mobile device may determine priorities with a modem processor that may be configured to exchange signals with the applications processor and/or technologies associated with the subscriptions. The modem processor may compare identified states of active subscriptions. Based on predefined priority information, such as data tables and/or equations, the modem processor may determine the active subscription that has a higher priority. For example, the modem processor may determine a first subscription's priority rank based on a data table entry, and compare that priority rank to a second subscription's priority rank to determine the subscription with the higher priority.

In another embodiment, when subscriptions have the same priority, the mobile device may utilize a tiebreaker algorithm to determine relative priorities of the active subscriptions based on certain characteristics of the states of the subscriptions. Such characteristics may include whether the subscription corresponds to the user originating a call, whether a subscription is transmitting information via a wireless wide area network as opposed to a wireless local area network, and whether the information is delay sensitive or not. In other embodiments, the mobile device may be configured to identify states and determine priorities in response to various conditions, such as the passage of a period of time, receiving user inputs, receiving pages from remote mobile devices, and/or other changes in the information related to active subscriptions. In another embodiment, the modem processor may be configured to identify subscription states when non-critical information is only known or available to the modem processor.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a diagram illustrating an embodiment mobile device that may include an applications processor and a modem processor for enabling a dual subscription, dual active (“DSDA”) configuration.

FIGS. 2A-2C are process flow diagrams illustrating embodiment methods for a mobile device to allocate resources based on determined priorities of the concurrently active subscriptions.

FIG. 3 is a process flow diagram illustrating an embodiment method for identifying states of subscriptions.

FIGS. 4A-4B are diagrams illustrating embodiment data tables for determining priorities among two active subscriptions.

FIG. 5 is a process flow diagram illustrating an embodiment method for a mobile device to determine priorities among concurrently active subscriptions based on identified changes in state.

FIG. 6 is a process flow diagram illustrating an embodiment method for a mobile device to allocate resources based on determined priorities among concurrently active subscriptions with missing non-critical state information.

FIGS. 7-9 are diagrams of call flows of embodiment mobile devices with concurrently active subscriptions.

FIG. 10 is a component block diagram of a mobile device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “subscription” is used herein to refer to a service or technology that is accessible on a mobile device and that is associated with a particular communication network and/or account. For example, a subscription may correspond to a data/talk service from AT&T, Verizon, or other network providers. Subscriptions may be affiliated with dedicated circuitry, modules, software instructions, and/or other components that enable the mobile device to exchange voice calls, media, or any data with various wireless networks such as wireless wide area networks (WWAN) including WCDMA, GSM, LTE, 3G, 4G or wireless local area networks (WLAN) including WiFi. In particular, a subscription may be associated with a subscriber identification module (SIM) that may store data for communicating over an access network.

The term “local-hold” (or “pseudo-hold”) is used herein to refer to a condition of a subscription in a mobile device in which the subscription may be active but not used by a user of a mobile device. Subscriptions may be configured to be on local-hold when the user is not conversing on the subscriptions but the networks associated with the subscriptions are unaware of the hold. In other words, local-hold may indicate inactivity of a first subscription of a mobile device relative to a second subscription of the mobile device. For example, a first subscription may be configured to be on local-hold when the user switches from the first subscription to converse on a second subscription. Conversely, the term “network-hold” is used herein to refer to a condition of the subscription that corresponds to the subscription being configured to be on hold in a manner of which a network is aware. For example, a voice call may be placed on network-hold when the cellular network associated with the call receives information indicating the voice call is on hold.

The various embodiments provide methods for prioritizing subscriptions (or communication technologies) for use in allocating radio link resources in dual-subscription, dual active (DSDA) mobile devices. When multiple subscriptions are concurrently used, an embodiment DSDA mobile device may identify the state of such active subscriptions by assessing the information being exchanged on the subscriptions. For example, the mobile device may identify the state of a subscription as “voice” or “data” based on the information actively being communicated. In various embodiments, identified states may include “voice-high” (i.e., a circuit-switch voice call on which the user is currently conversing), “voice-low” (i.e., a circuit-switch voice call on which the user is not currently conversing), “data” (i.e., packet-switch, best effort data, such as media or data files), and “baseline” (i.e., information not fitting into any other state). Additionally, the identified states may be based on the type of data or voice information being communicated with a network associated with a subscription, as well as the rate of data transfer, the quality of service required for the call, and/or delay sensitivity (e.g., voice information must not have transfer latency above a certain threshold, etc.).

Based on identified states, the mobile device may determine priorities for the active subscriptions. In general, the mobile device may determine that a subscription having a voice state (i.e., a subscription actively exchanging a voice call) has a higher priority than a subscription having a data state (i.e., a subscription exchanging best effort data). For example, a telephone subscription actively communicating a voice call may have higher priority than a subscription downloading/uploading an image file. In particular, when the mobile device identifies subscriptions supporting concurrent voice call (i.e., two active telephone calls), the subscription on which the user of the mobile device is actively conversing may be assigned a higher priority. For example, the subscription the user is currently talking on may be assigned a higher priority than another call on another subscription that is on local-hold. Further, a subscription in a baseline state may be assigned a higher priority than a subscription in a data state.

The mobile device may utilize the determined subscription priorities to allocate or manage device resources. In particular, the mobile device may use determined priorities to perform resource management operations that may include radio frequency (RF) exposure management (or radiation management), interference management, allocating battery current, allocating processing resources (e.g., million instructions per second or “MIPS”), battery power management, transmit power management, and thermal mitigation. For example, the higher priority subscription corresponding to a voice call on which the user is currently conversing may receive maximum transmit power, and a lower priority subscription supporting to a data transfer may receive minimum transmit power during the voice call. As another example, the low priority subscription may accommodate the high priority subscription by commencing transmit (Tx) blanking in favor of the higher priority subscription. However, if a subscription is already Tx blanking, the mobile device may increase the Tx blanking burden to the lower priority subscription to further accommodate the higher priority subscription. As another example, the mobile device may throttle the lower priority subscription or increase its throttling to accommodate the higher priority subscription. As a further example, the DSDA mobile device may have two antennas where one is blocked.

The mobile device may assign the unblocked antenna to the higher priority subscription and the blocked antenna to the lower priority subscription. In general, allocating resources (or otherwise executing resource management) may be performed by a dedicated resource management component, routine, operating system thread, or other module configured to route power, resources, processing cycles, modem resources, or other capabilities of the mobile device.

In an alternative embodiment, the mobile device may perform resource allocation operations when there is only a single subscription. For example, the mobile device may include a single subscription that is configured to support multiple, concurrently active communication technologies. As another example, the mobile device may support other communication technologies outside of modem-related processes that require resource management when only one subscription is active, such as connectivity-related modules or processes or software that support delay-sensitive applications on WLAN (e.g., WiFi Display).

As more complete information may provide more accurate assessments of subscription states and related priorities, resource allocation operations may be improved with aggregated information from the mobile device components performing subscription-related operations. Accordingly, the mobile device may utilize both an applications processor and a modem processor to prioritize concurrently active subscriptions. In particular, the applications processor may perform operations, such as executing in a high-level operating system, to manage concurrent subscriptions. However, the applications processor alone may not have access to adequate information to determine subscription priorities. For example, information regarding receiving and transmitting on a slot-by-slot basis with certain modem technologies may be unreported (or invisible) to the applications processor and the high-level operating system. As another example, throttling and blanking of one or more modem technologies may be invisible to the applications processor due to coexistence issues. The mobile device's modem processor, typically utilized to manage communication exchanges over a modem, may be equally having inadequate information to prioritize subscriptions alone. For example, the modem processor may have no access to information indicating whether the user is conversing on a voice call, conferencing (i.e., conversing on multiple voice calls), and/or supplying user interface data for switching between subscriptions. Thus, the mobile device may utilize the applications processor for subscription state identifications and the modem processor for priority determinations based on identified states.

In an embodiment, when the active subscriptions are identified as having a similar or the same state (e.g., both subscriptions are associated with data transfers/calls), the mobile device may utilize tiebreaker algorithms or logic to determine the subscription that has a higher priority. For example, the mobile device may store a data table that lists factors, characteristics, or other conditions that may be used to prioritize one subscription over another subscription having the same state. In an embodiment, the mobile device may break ties between subscriptions having the same state based on whether information transferred on a subscription includes delay-sensitive data (e.g., video data) and/or whether the subscription utilizes wireless wide area network (WWAN) or wireless local area network (WLAN) communication technologies. For example, a subscription corresponding to a WWAN voice call may have priority over another subscription corresponding to a WLAN voice call. In general, wireless wide area network communications may be communications, such as voice calls and/or data transfers, that are associated with a modem within the mobile device. For example, WWAN communications may include data transmissions over a cellular network via a modem, whereas WLAN communications may include data transmission to a wireless router via a wireless local area network interface.

In general, a mobile device may determine priorities for concurrently active subscriptions based on comparing identified states of the subscriptions and utilizing general (or macro) priority rules. For example, a data table may embody macro priority rules indicating that subscriptions corresponding to voice calls may be higher priority than subscriptions corresponding to data calls. As another example, if the mobile device is utilizing different technologies (e.g., WWAN and WLAN, WCDMA and GSM, etc.) for the dual subscriptions one subscription associated with a particular technology may have a higher macro priority than the other.

In various embodiments, the mobile device may also utilize more granulated (or micro) priority rules to determine priorities based on exceptional conditions. In other words, the mobile device may determine priorities that contradict macro priority rules. For example, the mobile device may determine that a first subscription corresponding to a data call has priority over a second subscription corresponding to a voice call when the data call relates to an emergency data transfer (e.g., an alarm, an emergency data backup, etc.). As another example, a data call (e.g., VOIP) may be temporarily determined as higher priority than a voice call when the mobile device determines that the data transfer rate of the data call has exceeded a predefined threshold. As a more specific example, a DSDA device may have a GSM subscription with a high macro priority and a WCDMA subscription with a low macro priority due to SAR management reasons. Thus, the mobile device may assign high transmitting power for the GSM subscription and low transmitting power for the WCDMA subscription based on the time-averaged power of the GSM subscription. However, the same DSDA device may assign high micro priority to the WCDMA subscription trumping the macro priority for radio frequency coexistent management reasons such as the WCDMA's phase-locked loop (PLL) tune and receive (Rx) automatic gain control loop (ACG) acquisition in compressed mode. To accommodate the change, the GSM subscription may commence Tx blanking to accommodate the WCDMA subscription.

In an embodiment, the mobile device may identify the subscription that the user is actively conversing on based on detected user interface events, such as button presses that switch from one voice call (or subscription) to the other. In another embodiment, the priorities may be determined by the mobile device utilizing a look-up table or alternatively an equation as a function of the states of the active subscriptions.

The various embodiment methods may be performed by embodiment mobile devices that include integrated baseband chips. For example, the modem processor described within this disclosure may be an integrated baseband processor or chip that may process all wireless signals received and/or transmitted by the mobile device. The use of such an integrated baseband chip is a key difference between the disclosed embodiments and other technologies, as the integrated baseband chip enables efficient coordination of resources between concurrently active subscriptions.

The various embodiments may be implemented in mobile devices configured to perform operations to support multiple concurrent subscriptions. The embodiment methods may have further application in dual-subscription, dual active mobile devices. For example, a mobile device configured to utilize concurrent technologies that are not communication subscriptions may execute the following embodiment methods to more efficiently allocate resources. Additionally, mobile devices having technologies that correspond to connectivity and that may not involve a modem, such as delay-sensitive applications that utilize a wireless local area network (e.g., WiFi Display) or Bluetooth radios, may also utilize the various embodiment methods to prioritize services or technologies and allocate mobile device resources.

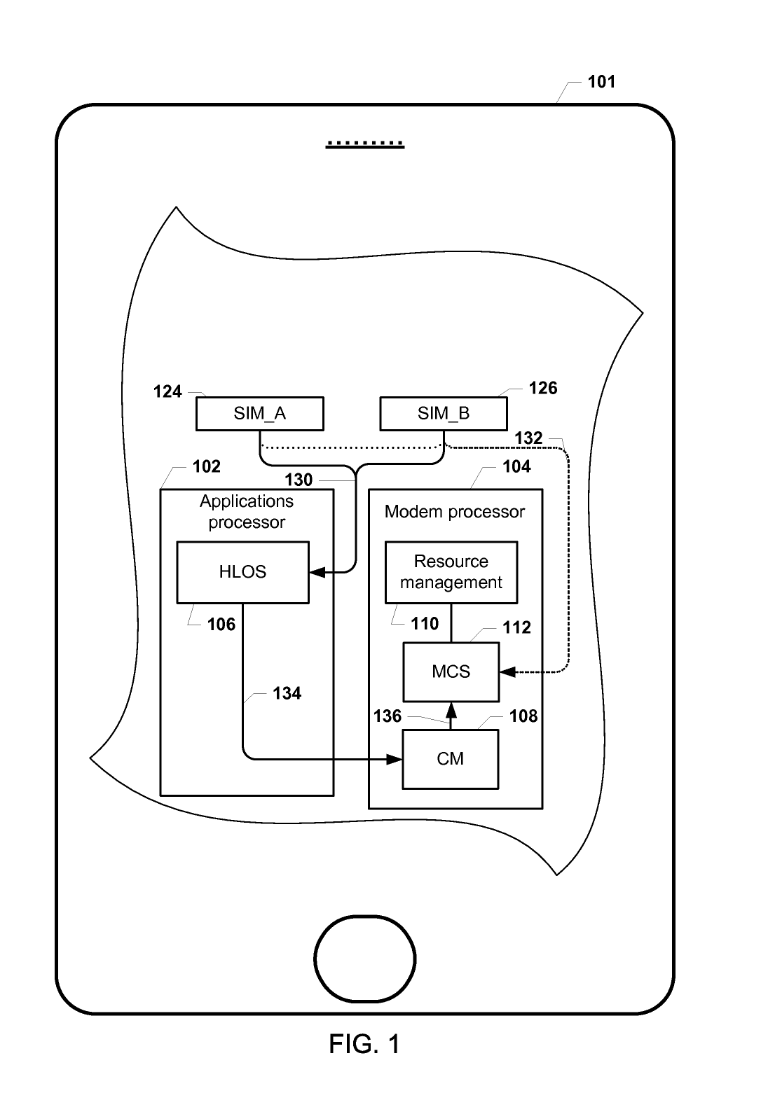

FIG. 1 is a block diagram of an embodiment dual subscription, dual active (DSDA) mobile device 101 that includes an applications processor 102 and a modem processor 104. The mobile device 101 may include a first SIM card (or chip) 124 (referred to in FIG. 1 as “SIM_A”) that is associated with a first subscription, and a second SIM card 126 (referred to in FIG. 1 as “SIM_B”) that is associated with a second subscription. In various embodiments, the SIM cards 124, 126 may be software, circuitry, routines, or modules that perform operations to utilize technology related to particular services and/or networks (e.g., LTE, 3G, etc.). For example, the first SIM card 124 may be used by the mobile device 101 to exchange voice and data information with a first access network and the second SIM card 126 may be used to exchange voice and data information with a second access network. Both SIM cards 124, 126 may exchange signals 130 with the applications processor 102. The applications processor 102 may be a primary processing unit of the mobile device 101 and may be used to perform operations related to a high-level operating system 106 (referred to in FIG. 1 as “HLOS”). The HLOS 106 may receive and process signals 130 from the SIM cards 124, 126, such as network identification keys, software, and other data related to incoming and outgoing voice and/or data packets. As described below, the signals 130 may indicate the state information of the subscriptions that the mobile device 101 may utilize to identify states for prioritizing the subscriptions.

The HLOS 106 may transmit signals 134 to a call manager 108 (referred to as “CM” in FIG. 1). The call manager 108 may be a module, circuitry, software, or other routines utilized by the modem processor 104 for communicating with the applications processor 102. The HLOS 106 may provide the call manager 108 with information that indicates updates, designations, settings, or other configurations of the SIM cards 124, 126 and/or the subscriptions. For example, the HLOS 106 may pass state information of active subscriptions to the call manager 108. In an embodiment, the HLOS 106 may have a radio interface layer, or software component for each subscription the mobile device 101 is configured to support. Such radio interface layers may be used by the mobile device 101 for facilitating data flow between software or applications running on the applications processor 102 and hardware of the mobile device 101, such as a modem. Although the call manager 108 is illustrated in the modem processor 104, the call manager may be in the applications processor 102.

The call manager 108 may bundle information received via signals 134 (e.g., subscription state information, SIM designation information, etc.) and transmit signals 136 to a modem common services 112 component (referred to as “MCS” in FIG. 1). The MCS 112 may be executed, supported, and/or otherwise controlled by the modem processor 104. In an embodiment, the MCS 112 may match signals 136 to active technologies (such as active subscriptions) using active subscription identifiers. The MCS 112 may invoke resource allocation or management algorithms of a resource management component 110 based on receiving the signals 136 and determining priorities of active subscriptions associated with the SIM cards 124, 126. In an embodiment, the modem processor 104 may receive information via signals 132 from the SIM cards 124, 146. For example, the signals 132 may include non-critical state information the modem processor 104 may utilize to identify a subscription that is transmitting data as opposed to voice information and/or to identify a subscription that is on local-hold.

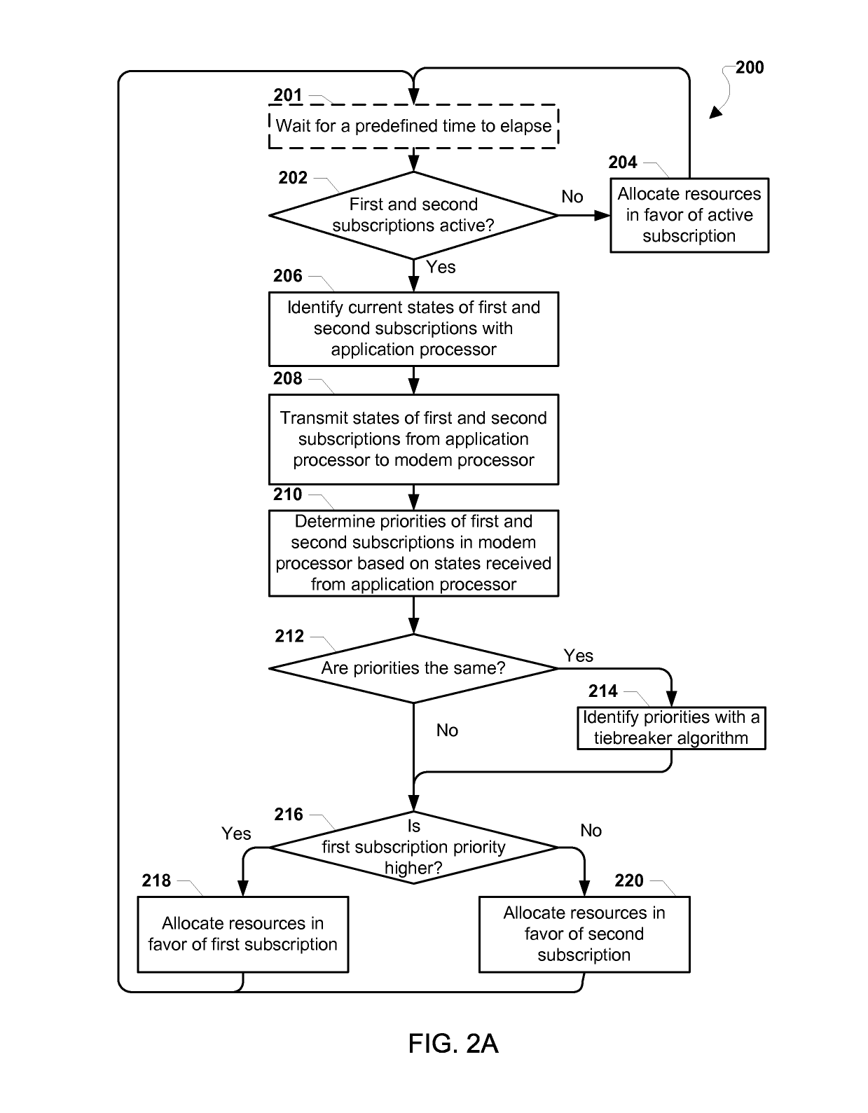

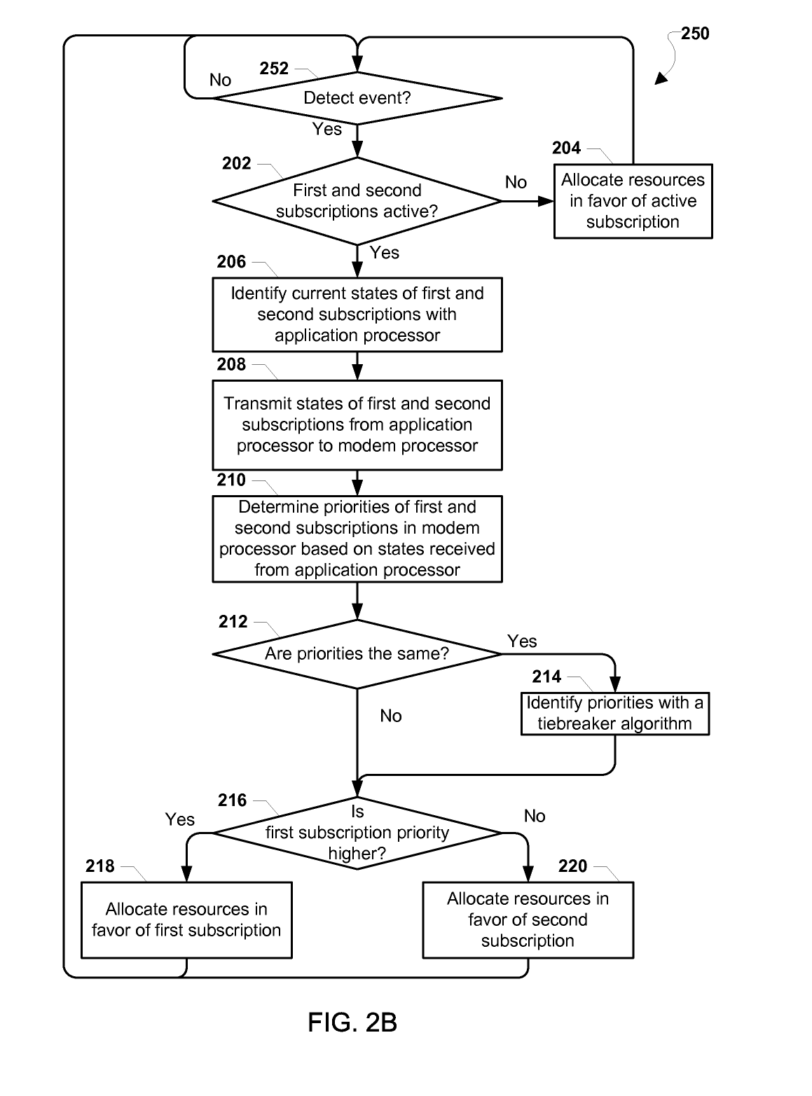

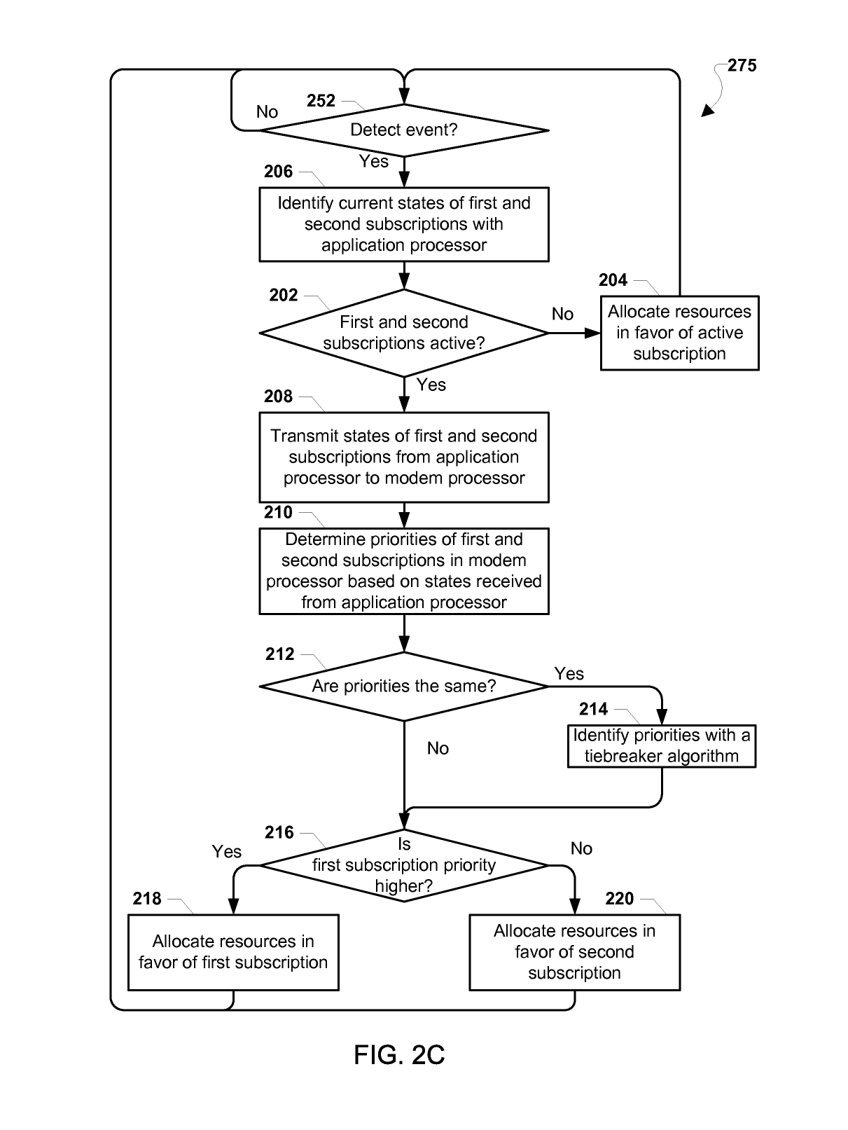

FIG. 2A illustrates an embodiment method 200 for a mobile device allocating resources based on determined priorities of the concurrently active subscriptions. In optional block 201, the mobile device may wait for a predefined time to elapse. For example, the mobile device may perform the operations of the method 200 periodically, pausing for a second, many seconds, or a minute before evaluating (or re-evaluating) active subscription priorities. In determination block 202, the mobile device may determine whether a first subscription and a second subscription are active. In an embodiment, a subscription may be active only when a modem technology related to the subscription is in a “traffic” state (i.e., a transmitter is enabled, a transmission is in progress, etc.) or a “system access” state (e.g., information is being received indicating network status, the subscription is logged-in, etc.). If the first and second subscriptions are not both active (i.e., determination block 202=“No”), in block 204 the mobile device may allocate resources in favor of the active subscription and may continue with the operations in optional block 201. For example, a transceiver utilized by the mobile device for communicating via the active subscription may receive maximum transmitting power. In an embodiment, no resource management operations may need to be performed by the mobile device when only a single subscription is active.

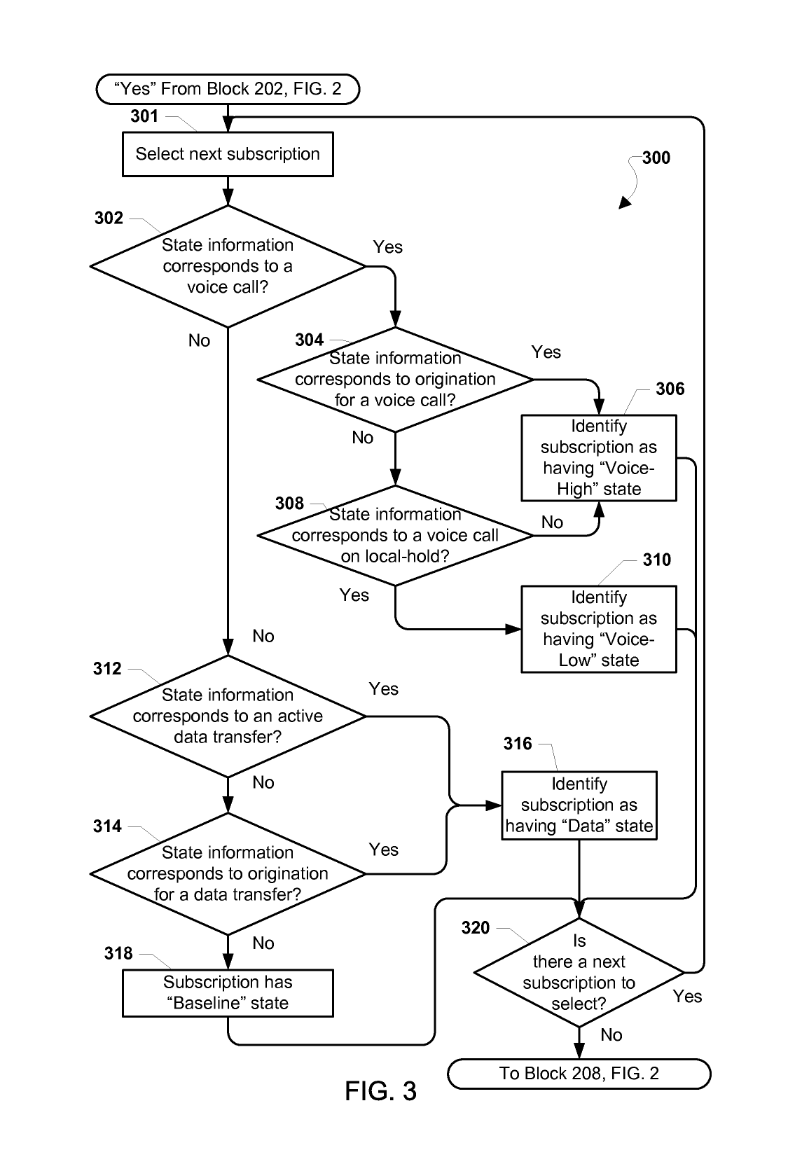

If the first and second subscriptions are determined to be active (i.e., determination block 202=“Yes”), in block 206 the mobile device may identify the current states of the first and second subscriptions with the applications processor. The operations of block 206 may be as described below with reference to FIG. 3. In block 208, the mobile device may transmit the identified states of the first and second subscriptions from the applications processor to the modem processor. For example, a call manager associated with the applications processor may transmit signals to a modem common services component associated with the modem processor, as described above.

In block 210, the mobile device may determine priorities of the first and second subscriptions in the modem processor based on states received from the applications processor. The modem processor may compare the identified states of the subscriptions and determine whether one state is recognized as having a higher priority than the other. In other words, the modem processor may determine the relative priorities of the subscriptions. In an embodiment, subscriptions having voice states (i.e., subscriptions corresponding to voice calls) may have higher priority than subscriptions having data states and/or baseline states. Further, subscriptions having “voice-high” states, such as when a user is conversing on a voice call, may be higher priority than subscriptions having “voice-low” states, such as when an active voice call is on local-hold (e.g., the user is not conversing on the voice call). Subscriptions having data states may be the lowest priority.

In an embodiment, the mobile device may compare the states of the first and second subscriptions by utilizing a look-up table that indicates all possible states and whether a particular state is assigned a higher or lower priority than any other possible state. In another embodiment, the mobile device may compare states by performing an equation or function that may take a state and generate a priority ranking. For example, the mobile device may input the first and second subscription states and assign priority rankings for each, or alternatively, may generate an indication of the higher priority subscription.

In determination block 212, the mobile device may determine whether the first and second subscriptions' priorities are the same. In an embodiment, the mobile device may determine that the subscriptions have the same priority when both subscriptions' states are the same. For example, the priorities may be the same when the first subscription has a “data” state and the second subscription also has a “data” state (e.g., both subscriptions are actively transmitting data via the modem). If the priorities are the same (i.e., determination block 212=“Yes”), in block 214 the mobile device may identify priorities with a tiebreaker algorithm. The mobile device may be configured to distinguish between otherwise similar subscription states by utilizing tiebreaking rules that determine priority based on more detailed characteristics of the subscriptions. For example, when the first and second subscriptions have “voice-high” states, the mobile device may utilize the tiebreaker algorithm to identify the first subscription as having priority based on the first subscription also including video or display information (e.g., a video call). The tiebreaker algorithm may also identify priority based on a subscription including delay sensitive data. For example, a subscription that corresponds to delay-sensitive data may be identified as being higher priority than both a subscription corresponding to idle/paging data and a subscription corresponding to non-delay sensitive data.

In an embodiment, the tiebreaker algorithm may identify priorities based on the type of network over which the mobile device is communicating via the subscriptions. In particular, the tiebreaker algorithm may recognize that communications on a subscription associated with a wireless wide area network (e.g., communications that utilize a cellular network modem for exchanging information with a cellular network) have higher priority than communications on a subscription associated with a wireless local area network (e.g., communications that utilize a wireless network card for exchanging information with a wireless router). The tiebreaker algorithm may also determine priority using other related conditions of the subscriptions, such as whether they are related to short-range radio signals (e.g., Bluetooth®, Zigbee®, Peanut®, etc.) or global positioning system data. In another embodiment, when the first and second subscriptions are both active as part of a conference call (i.e., conferencing), the mobile device may identify an arbitrary priority (e.g., the mobile device may designate a “share the pain” resource allocation that impacts both subscriptions). In an embodiment, if the subscriptions both have “data” states, the subscription that is transmitting data for system access may be higher priority than the subscription transmitting “best-effort” data. In various embodiments, the tiebreaker algorithm may be routines, modules, or other components stored within volatile memory and executed by the applications processor and/or the modem processor. For example, the tiebreaker algorithm may utilize a tiebreaker data table that indicates ranked or prioritized attributes, conditions, or other identifiers that the mobile device may use to identify priorities of the two subscriptions having similar states.

In another embodiment, the tiebreaker algorithm may include rules or other logic common to dual subscription, dual standby (or “DSDS”) mobile devices that are configured to support two subscriptions with only one subscription active at a given time (i.e., a DSDS mobile device may have only one active radio). In particular, when two subscriptions corresponding to voice calls are concurrently active, the tiebreaker algorithm may determine the subscription corresponding to a voice call that was originated by the user as having higher priority. For example, the mobile device may identify a higher priority for a subscription based on an origination event by the user.

Alternatively, the tiebreaker algorithm may determine priority based on default subscription indicators. In other words, when two subscriptions have the same determined priority, the default subscription indicator may designate the subscription that has the higher priority by default. For example, the mobile device may store a default voice subscription indicator that indicates which of two subscriptions supporting similar voice calls is the default voice subscription and thus the subscription with a higher priority. Additionally, when two subscriptions corresponding to data transfers/calls are concurrently active, the tiebreaker algorithm may determine the subscription that is indicated by a default data subscription indicator as the default data transfer/call subscription that has higher priority. In an embodiment, the mobile device may store a general default priority subscription indicator for use by the tiebreaker algorithm when two subscriptions have the same priority. For example, when two subscriptions corresponding to baseline states are concurrently active, the tiebreaker algorithm may identify the subscription that is indicated by the default priority subscription indicator as having higher priority.

If the priorities are not the same (i.e., determination block 212=“No”) or if priorities have been identified with the tiebreaker algorithm, in determination block 216 the mobile device may determine whether the first subscription priority is higher. In other words, the mobile device may determine whether the first subscription has priority over the second subscription. If the first subscription has a higher priority (i.e., determination block 216=“Yes”), in block 218 the mobile device may allocate resources in favor of the first subscription and may continue with the operations in optional block 201. For example, a transceiver/antenna may receive full transmit power for communications associated with the first subscription. If the first subscription does not have a higher priority (i.e., determination block 216=“No”), in block 220 the mobile device may allocate resources in favor of the second subscription and may continue with the operations in optional block 201.

In an embodiment, the DSDA mobile device 101 may increase Tx blanking burden to the lower priority subscription. For example in a DSDA device with a WCDMA subscription as a high priority and the GSM subscription as a low priority, the WCDMA subscription may only commence Tx blanking to accommodate two downlink (DL) slots. However, if the macro priorities are changed such that the GSM subscription has a higher priority than the WCDMA subscription, the WCDMA subscription accommodates the higher priority GSM subscription by increasing its burden or increasing Tx blanking from protecting two GSM DL slots to three GSM DL slots.

In an alternative embodiment, the DSDA mobile device 101 may increase throttling to a lower priority subscription. For example, in a DSDA mobile device with a high priority GSM subscription and a low priority WCDMA subscription, the mobile device may give preference to the GSM subscription by not throttling the GSM subscription, throttling the GSM subscription only by half and/or throttling the GSM subscription opportunistically by using idle frames for Frequency Correction Channel (FCCH) and synchronization channel (SCH) acquisitions. Alternatively, when the WCDMA subscription has a high priority (either through micro priorities or through macro priorities) and the GSM subscription has a low priority, the GSM subscription may increase its throttling from zero to a half or from a half to a third.

In an embodiment, the DSDA mobile device 101 may have two antennas and allocate the antenna with the best reception to the higher priority subscription. For example, when one antenna is blocked by a hand and the other antenna is not, the mobile device will assign the unblocked antenna to the higher priority subscription and the blocked antenna to the lower priority subscription. In an alternative embodiment, the modem of a DSDA mobile device may have a specific battery current allocation for the modem to split between the dual subscriptions. When operating two subscription services, the mobile device may allocate a higher amount of the available current to the higher priority subscription than the lower priority subscription. This may be particularly relevant when the battery charge is almost depleted allowing the mobile device to shift the remaining resources to the higher priority subscription rather than starve both.

FIG. 2B illustrates an embodiment method 250 for a mobile device determining priorities of the concurrently active subscriptions. The method 250 is similar to the method 200, except that the operations in the method 250 may be performed repeatedly in response to detected events, such as receiving a user input. For example, once states are identified for concurrent active subscriptions and resources are allocated based on determined priorities, the mobile device may only identify subsequent subscription states in response to receiving a page from another mobile device. As another example, the mobile device may detect an input when the user presses a “SEND” button that indicates the user is originating a voice call on a first subscription, and therefore a second subscription's voice call on local-hold should have a lower priority. In other words, the method 250 may be repeated not based on an elapsed time, but instead in response to detected occurrences, triggers, or other inputs that indicate a change in use of the mobile device. In this manner, a mobile device executing the embodiment method 250 may tap into the intention of the user by only detecting changes in subscription priorities and allocating mobile device resources in response to activities of the user (e.g., providing user inputs on a graphical user interface, etc.).

In determination block 252, the mobile device may determine whether an event is detected. Events may include receiving a user input, losing connectivity on a subscription communication, detecting predefined changes in the information associated with a subscription, and/or receiving a page from another mobile device. For example, the mobile device may determine whether an input mechanism, such as the use of slider, ordering a list, a reset, power, “end call”, or “switch calls” button, has been engaged or pressed by the user. In an embodiment, an event may be detected when a headphone jack is engaged. In another embodiment, an event may be detected when sensor data is detected. For example, the mobile device may determine a user input event has occurred when accelerometer or gyroscope sensor data indicates that the user has tapped, hit, or moved the mobile device. In another embodiment, events may also be detected when the mobile device receives signals on a certain frequency or channel and/or a processor-idle-status (or modem-idle-status) threshold is exceeded. If the mobile device does not detect an event (i.e., determination block 252=“No”), the mobile device may continue monitoring for events in determination block 252.

When the mobile device detects an event (i.e., determination block 252=“Yes”), in determination block 202 the mobile device may determine whether a first subscription and a second subscription are active. If the first and second subscriptions are not both active (i.e., determination block 202=“No”), in block 204 the mobile device may allocate resources in favor of the active subscription and may continue monitoring for events in determination block 252. If the first and second subscriptions are determined to be active (i.e., determination block 202=“Yes”), in block 206 the mobile device may identify the current states of the first and second subscriptions with the applications processor. In block 208, the mobile device may transmit the identified states of the first and second subscriptions from the applications processor to the modem processor. In block 210, the mobile device may determine priorities of the first and second subscriptions in the modem processor based on states received from the applications processor. In determination block 212, the mobile device may determine whether the first and second subscriptions' priorities are the same. If the priorities are the same (i.e., determination block 212=“Yes”), in block 214 the mobile device may identify priorities with a tiebreaker algorithm.

If the priorities are not the same (i.e., determination block 212=“No”) or if priorities have been identified with the tiebreaker algorithms, in determination block 216 the mobile device may determine whether the first subscription priority is higher. If the first subscription has a higher priority (i.e., determination block 216=“Yes”), in block 218 the mobile device may allocate resources in favor of the first subscription and may continue monitoring for events in determination block 252. If the first subscription does not have a higher priority (i.e., determination block 216=“No”), in block 220 the mobile device may allocate resources in favor of the second subscription and may continue monitoring for events in determination block 252.

FIG. 2C illustrates an embodiment method 275 for a mobile device determining priorities of the concurrently active subscriptions. The method 275 is similar to method 250 described above, except that subscription states may be identified by the mobile device prior to determining whether two subscriptions are concurrently active. In this manner, the mobile device may identify (and store) states for subscriptions even when communications associated with the subscriptions are inactive. For example, after detecting a user input for ending a voice call on a first subscription, the mobile device may identify the state of the first subscription as “baseline.” By executing the method 275, the mobile device may maintain up-to-date states for subscriptions even when the subscriptions may not be actively involved in transmitting information.

In determination block 252, the mobile device may determine whether an event is detected. If the mobile device does not detect an event (i.e., determination block 252=“No”), the mobile device may continue monitoring for events in determination block 252. When the mobile device detects an event (i.e., determination block 252=“Yes”), in block 206 the mobile device may identify the current states of the first and second subscriptions with the applications processor. In determination block 202 the mobile device may determine whether a first subscription and a second subscription are active. If the first and second subscriptions are not both active (i.e., determination block 202=“No”), in block 204 the mobile device may allocate resources in favor of the active subscription and may continue with the operations in determination block 252. If the first and second subscriptions are determined to be active (i.e., determination block 202=“Yes”), in block 208, the mobile device may transmit the identified states of the first and second subscriptions from the applications processor to the modem processor. In block 210, the mobile device may determine priorities of the first and second subscriptions in the modem processor based on states received from the applications processor. In determination block 212, the mobile device may determine whether the first and second subscriptions' priorities are the same. If the priorities are the same (i.e., determination block 212=“Yes”), in block 214 the mobile device may identify priorities with a tiebreaker algorithm.

If the priorities are not the same (i.e., determination block 212=“No”) or if priorities have been identified with the tiebreaker algorithms, in determination block 216 the mobile device may determine whether the first subscription priority is higher. If the first subscription has a higher priority (i.e., determination block 216=“Yes”), in block 218 the mobile device may allocate resources in favor of the first subscription and may continue with the operations in determination block 252. If the first subscription does not have a higher priority (i.e., determination block 216=“No”), in block 220 the mobile device may allocate resources in favor of the second subscription and may continue with the operations in determination block 252.

FIG. 3 illustrates an embodiment method 300 for identifying states of subscriptions. The operations in method 300 may be performed by the mobile device in place of or during the operations of block 206 as described above with reference to FIG. 2A. For example, the mobile device may perform the operations of method 300 in response to determining that a first and second subscription are both active (i.e., determination block 202=“Yes”). In various embodiments, the operations in the method 300 may be performed by the applications processor, the modem processor, or any other processing unit within the mobile device. For example, the modem processor may receive state information from the applications processor and/or a subscription, and in turn may identify states, such as determining whether the subscription is in a “data” state.

In general, the mobile device may evaluate the characteristics, conditions, use, timing, and other information related to signals corresponding to a subscription (collectively referred to as “state information”) to identify the subscription's state. State information may indicate detected events, such as received user inputs. In an embodiment, there may be four possible states of a subscription that may be identified based on the state information of the subscriptions at a given time. The “voice-high” state may relate to a voice call that has been originated by the mobile device (i.e., the user of the mobile device initiated the phone call) or on which the user of the mobile device is currently conversing. In an embodiment, when there is only one active subscription that corresponds to a voice call, the subscription may be in a “voice-high” state. The “voice-low” state may relate to a voice call that is active but on local-hold (i.e., the user of the mobile device is not conversing on the subscription). A subscription may only have a “voice-low” state when there is a concurrent “voice-high” subscription. In other words, the “voice-low” state may only exist when there are two active voice calls on two subscriptions in the mobile device. The “data” state may relate to transmissions that are exclusively data. A subscription may be in a “data” state when the subscription is exchanging any best-effort data (i.e., the subscription is originated as a data call or participating in a data call that is active, connected, or in a traffic state). The “baseline” state may be related to any other condition not indicated in the above descriptions. In other words, a subscription may be in the “baseline” state when it is not participating in a “voice-high,” “voice-low,” or “data” state transmission. The “baseline” state may correspond to state information indicating paging for voice or data calls, registrations for voice or data calls without the mobile device's high-level operating system receiving any indication of such registrations, and/or that the subscription is idling when the transmitter is configured to be deactivated (or ‘off’). In an embodiment, a subscription may be in the “baseline” state when the subscription's state information is unknown by the mobile device. In other embodiments, a subscription may be in the “baseline” state when the subscription is engaged in a wireless wide area network page response for voice and/or data, wireless wide area network registrations for voice and/or data without the mobile device's high-level operating system being aware of the registrations, wireless wide area network idling when the mobile device's wireless wide area network transmitter is configured to be inactive (i.e., “off”), or wireless local area network idling when the wireless local area network transmitter is configured to be inactive.

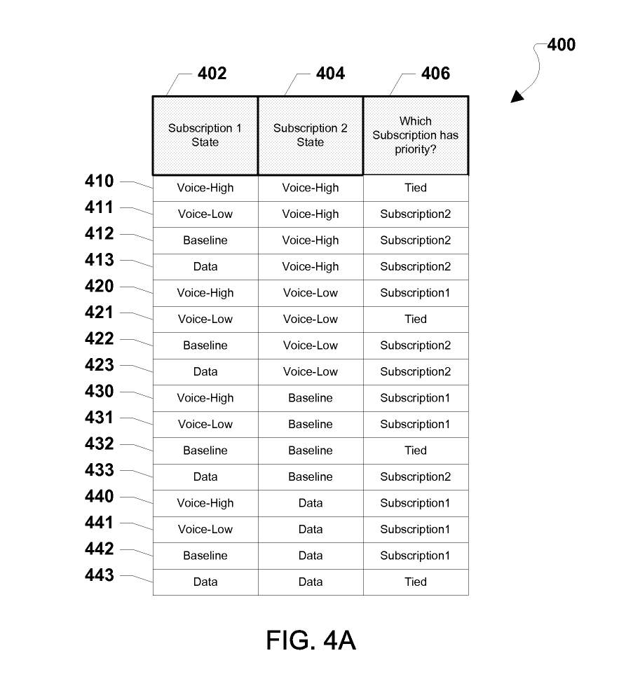

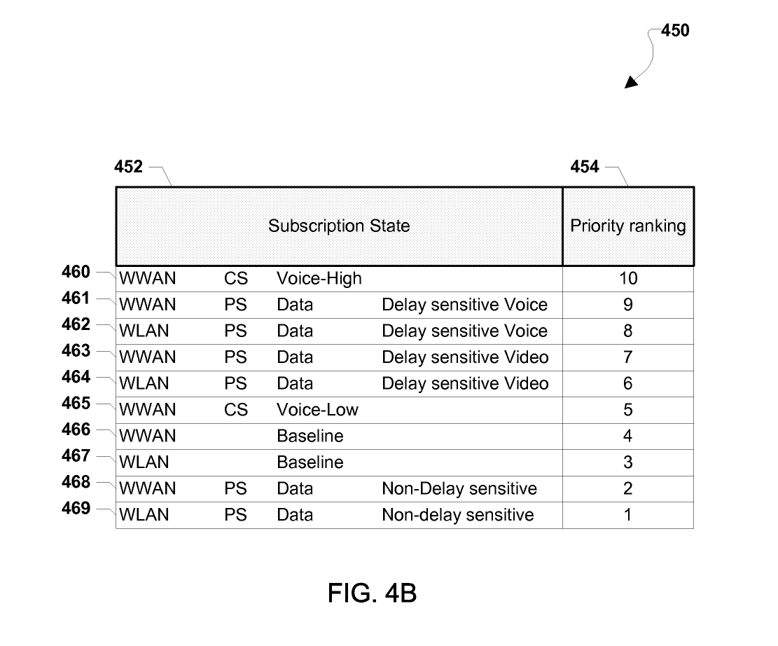

In alternative embodiments, subscriptions may be identified as having states other than “voice-high,” “voice-low,” “baseline,” and “data,” and therefore these states may not be exhaustive for all embodiments. For illustration, a mobile device may utilize a subscription to transfer a particular type of data, such as a delay-tolerant (or delay-sensitive) data, and the subscription may be identified as having a state that is more specific than “data.” For example, a subscription may be identified as having a “data delay sensitive” state or a “data non-delay sensitive” state. Additionally, states may exist that more precisely describe subscriptions related to voice calls, and may include gradated indicators that describe varying degrees of quality of service and/or information associated with the voice calls. For example, an alternative embodiment mobile device may be configured to identify a subscription as having a “voice-medium” state. As another example, voice calls may be identified as relating to only voice information (e.g., a telephone call) or relating to voice and video (e.g., a Facetime application video call). In various embodiments, active voice calls may have higher priority than active voice and video calls. Further, states may include numerous other attributes that describe the characteristics of the data, call, or other information transmitted using an active subscription. For example, a state may include an indicator of whether the information relates to a wireless wide area network communication, a wireless local area network communication, packet-switch data, and/or circuit switch data. FIG. 4B described below illustrates other possible embodiment states.

In block 301, the mobile device may select a next subscription. The mobile device may run a software routine that may perform an operational loop comprised of the operations of the method 300 on the active subscriptions individually. For example, the mobile device may select the first subscription for one iteration of the operational loop and may select the second subscription for the next iteration of the loop.

In determination block 302, the mobile device may determine whether state information corresponds to a voice call, such as, for instance, the state information related to the selected subscription. For example, the mobile device may determine whether the selected subscription corresponds to (or is engaged in) a voice call as opposed to a data call. If the state information does correspond to a voice call (i.e., determination block 302=“Yes”), in determination block 304, the mobile device may determine whether the state information corresponds to an origination for a voice call. The mobile device may evaluate the state information, such as information describing detected user input events, to determine whether the user initiated the voice call on the subscription. For example, the state information may indicate an origination event coinciding with the user hitting the “SEND” button. In an embodiment, the state information may be bits or other indicators within signals transmitted by the subscription that indicate origination. In another embodiment, when the mobile device has not yet received incoming data related to the voice call on the subscription, the mobile device may assume origination. If the state information does correspond to an origination (i.e., determination block 304=“Yes”), in block 306 the mobile device may identify the subscription as having a “voice-high” state.

If the state information does not correspond to an origination for a voice call (i.e., determination block 304=“No”), in determination block 308 the mobile device may determine whether the state information corresponds to a voice call on local-hold. For example, the mobile device may determine whether the user has placed the subscription voice call on local-hold or has otherwise switched away from actively conversing on the voice call. If the state information does not correspond to a local-hold voice call (i.e., determination block 308=“No”), in block 306 the mobile device may identify the subscription as having a “voice-high” state. If the state information does correspond to a local-hold voice call (i.e., determination block 308=“Yes”), in block 310 the mobile device may identify the subscription as having a “voice-low” state.

If the state information does not correspond to a voice call (i.e., determination block 302=“No”), in determination block 312 the mobile device may determine whether the state information corresponds to an active data transfer. For example, the mobile device may determine whether the subscription is currently engaged in a system access communication or other data call. If the state information does correspond to an active data transfer (i.e., determination block 312=“Yes”), in block 316 the mobile device may identify the subscription as having a “data” state. If the state information does not correspond to an active data transfer (i.e., determination block 312=“No”), in determination block 314 the mobile device may determine whether the state information corresponds to an origination for a data transfer. For example, the mobile device (or the user) may be attempting to initiate a data transfer/call on the subscription. If the state information does correspond to an origination for a data transfer (i.e., determination block 314=“Yes”), in block 316 the mobile device may identify the subscription as having a “data” state. If the state information does not correspond to an origination for a data call (i.e., determination block 314=“No”), in block 318 the mobile device may identify the subscription as having a “baseline” state.

After the mobile device identified the state for the subscription, in determination block 320 the mobile device may determine whether there is a next subscription to select. If there is a next subscription (i.e., determination block 320=“Yes”), the mobile device may continue with the operations in block 301. However, if there is not a next subscription (i.e., determination block 320=“No”), the mobile device may end the method 300. In an embodiment, the mobile device may continue with the operations in block 208 as described above with reference to FIG. 2A.

FIG. 4A illustrates an embodiment data table 400 for determining priorities among two active subscriptions. As described above, a mobile device's modem processor may receive information, such as identified states, from a high-level operating system executing on the mobile device's applications processor. In particular, the modem processor may receive data that indicates the current identified states of a first subscription and a second subscription. For example, the modem processor may receive information indicating the first subscription has a current state of “voice-high” and the second subscription has a current state of “data”. Based on the received states, the modem processor may determine relative priorities of the two subscriptions.

In an embodiment, the modem processor may utilize a data table 400 to determine the relative priorities. The data table 400 may include a first data column 402 related to possible states of the first subscription, a second data column 404 related to possible states of the second subscription, and a third data column 406 including assessments of the subscription that has higher priority based on values in the first data column 402 and second data column 404. In other words, the third data column 406 may include priority values. In various embodiments, the possible state values within the first data column 402 and second data column 404 may be “voice-high,” “voice-low,” “baseline,” and “data,” and the possible priority values within the third data column 406 may include values that indicate the first subscription has a higher priority (i.e., “Subscription1”), the second subscription has a higher priority (i.e., “Subscription2”), and that neither subscription has a higher priority (i.e., “Tied”). In alternative embodiments, the possible state values may include additional values. For example, there may be a state value that indicates a particular type of data (e.g., video data, delay sensitive data, etc.)

The data table 400 may include data rows 410-443 for the various combinations of possible values of the subscription states in the data columns 402, 404. In particular, a first data row 410 may include a “voice-high” state value in the first data column 402, a “voice-high” state value in the second data column 404, and a “Tied” priority value in the third data column 406 indicating that both subscriptions have the same priority based on their current states. A second data row 411 may include a “voice-low” state value in the first data column 402, a “voice-high” state value in the second data column 404, and a “Subscription2” priority value in the third data column 406 indicating that the second subscription has a higher priority. A third data row 412 may include a “baseline” state value in the first data column 402, a “voice-high” state value in the second data column 404, and a “Subscription2” priority value in the third data column 406 indicating that the second subscription has a higher priority. A fourth data row 413 may include a “data” state value in the first data column 402, a “voice-high” state value in the second data column 404, and a “Subscription2” priority value in the third data column 406 indicating that the second subscription has a higher priority.

A fifth data row 420 may include a “voice-high” state value in the first data column 402, a “voice-low” state value in the second data column 404, and a “Subscription1” priority value in the third data column 406 indicating that the first subscription has a higher priority. A sixth data row 421 may include a “voice-low” state value in the first data column 402, a “voice-low” state value in the second data column 404, and a “Tied” priority value in the third data column 406 indicating that both subscriptions have the same priority based on their current states. A seventh data row 422 may include a “baseline” state value in the first data column 402, a “voice-low” state value in the second data column 404, and a “Subscription2” priority value in the third data column 406 indicating that the second subscription has a higher priority. An eighth data row 423 may include a “data” state value in the first data column 402, a “voice-low” state value in the second data column 404, and a “Subscription2” priority value in the third data column 406 indicating that the second subscription has a higher priority.

A ninth data row 430 may include a “voice-high” state value in the first data column 402, a “baseline” state value in the second data column 404, and a “Subscription1” priority value in the third data column 406 indicating that the first subscription has a higher priority. A tenth data row 431 may include a “voice-low” state value in the first data column 402, a “baseline” state value in the second data column 404, and a “Subscription1” priority value in the third data column 406 indicating that the first subscription has a higher priority. An eleventh data row 432 may include a “baseline” state value in the first data column 402, a “baseline” state value in the second data column 404, and a “Tied” priority value in the third data column 406 indicating that both subscriptions have the same priority based on their current states. A twelfth data row 433 may include a “data” state value in the first data column 402, a “baseline” state value in the second data column 404, and a “Subscription2” priority value in the third data column 406 indicating that the second subscription has a higher priority.

A thirteenth data row 440 may include a “voice-high” state value in the first data column 402, a “data” state value in the second data column 404, and a “Subscription1” priority value in the third data column 406 indicating that the first subscription has a higher priority. A fourteenth data row 441 may include a “voice-low” state value in the first data column 402, a “data” state value in the second data column 404, and a “Subscription1” priority value in the third data column 406 indicating that the first subscription has a higher priority. A fifteenth data row 442 may include a “baseline” state value in the first data column 402, a “data” state value in the second data column 404, and a “Subscription1” priority value in the third data column 406 indicating that the first subscription has a higher priority. A sixteenth data row 443 may include a “data” state value in the first data column 402, a “data” state value in the second data column 404, and a “Tied” priority value in the third data column 406 indicating that both subscriptions have the same priority based on their current states.

As described above, the embodiment data table 400 may be only one way a mobile device (e.g., a modem processor within the mobile device) may determine priorities of the concurrently active subscriptions. In other embodiments, the mobile device may use functions, software instructions, and stored historical data to determine priority of subscriptions based on identified states. For example, in an embodiment, the mobile device may input subscription identities (e.g., “Subscription1,” etc.) and identified states into a software function that may output the identity of the subscription with the higher priority. As another example, the mobile device may execute an operating system thread, software module, or other routine that evaluates stored historical data related to subscriptions to determine the priority of concurrently active subscriptions.

FIG. 4B illustrates another embodiment data table 450 for determining priorities among two active subscriptions. In an embodiment, once states have been identified for concurrent subscriptions, a mobile device may perform a look-up operation on the data table 450. The mobile device may compare a subscription's identified state to the values in the first data column 452 that indicate embodiment subscription states. As described above, various embodiments may identify different states that may correspond to broad characteristics or conditions of a subscription (e.g., “data,” “voice,” “baseline”) or alternatively very specific characteristics or conditions of the subscription. For example, a very specific state may correspond to numerous characteristics of the subscription's activities and communication protocols, such as by indicating the network used (e.g., wireless wide area network, wireless local area network, etc.) and the type of data being transmitted (e.g., delay sensitive video data). Once the mobile device matches a value in the first data column 452 with the identified state of a subscription, the mobile device may find the corresponding priority ranking in a related second data column 454. The mobile device may compare priority rankings for concurrently active subscriptions, and may determine the subscription with the higher priority ranking from the second data column 454 has the higher priority. For example, a first subscription with a “9” priority ranking from the second data column 454 may be assigned a higher priority than a second subscription with a “5” priority ranking.

For illustration purposes, the data table 450 may include data rows 460-469 for possible subscription states for an embodiment. The data rows 460-469 may be in descending priority order, as each successive row has a lower priority ranking in the second data column 454. A first data row 460 may correspond to a “WWAN CS Voice-High” subscription state that may describe a subscription that is exchanging wireless wide area network, circuit-switch, “voice-high” information, such as a voice call a user is current conversing on, and that may have a highest priority ranking of “10.” A second data row 461 may correspond to a “WWAN PS Data Delay sensitive Voice” subscription state that may describe a subscription that is exchanging wireless wide area network packet-switch data that is related to a delay sensitive voice call and that may or may not include video data. The second data row 461 may correspond to a priority ranking of “9.” A third data row 462 may correspond to a “WLAN PS Data Delay sensitive Voice” subscription state that may describe a subscription that is exchanging wireless local area network packet-switch data that is related to a delay sensitive voice call and that may or may not include video data. The third data row 462 may correspond to a priority ranking of “8.” A fourth data row 463 may correspond to a “WWAN PS Data Delay sensitive Video” subscription state that may describe a subscription that is exchanging wireless wide area network packet-switch data that is related to delay sensitive video data and that is not related to a voice call. The fourth data row 463 may correspond to a priority ranking of “7.” A fifth data row 464 may correspond to a “WLAN PS Data Delay sensitive Video” subscription state that may describe a subscription that is exchanging wireless local area network packet-switch data that is related to delay sensitive video data and that is not related to a voice call. The fifth data row 464 may correspond to a priority ranking of “6.” A sixth data row 465 may correspond to a “WWAN CS Voice-Low” subscription state that may describe a subscription that is exchanging wireless wide area network, circuit-switch, “voice-low” information, such as a voice call on local-hold, and that may have a priority ranking of “5.” A seventh data row 466 may correspond to a “WWAN Baseline” subscription state that may describe a subscription that is exchanging wireless wide area network baseline information, such as a page response for voice and/or data, and that may have a priority ranking of “4.” An eighth data row 467 may correspond to a “WLAN Baseline” subscription state that may describe a subscription that is exchanging wireless local area network baseline information, such as when the mobile device is in local area network idling with a transmitter configured to be inactive, and that may have a priority ranking of “3.” A ninth data row 468 may correspond to a “WWAN PS Data Non-Delay sensitive” subscription state that may describe a subscription that is exchanging wireless wide area network packet-switch data that is related to non-delay sensitive data, such as a wide area network data call in an active/connected/traffic state. The ninth data row 468 may correspond to a priority ranking of “2.” A tenth data row 469 may correspond to a “WLAN PS Data Non-Delay sensitive” subscription state that may describe a subscription that is exchanging wireless local area network packet-switch data that is related to non-delay sensitive data, such as a local area network data call in an active/connected/traffic state. The tenth data row 469 may correspond to a lowest priority ranking of “1.”

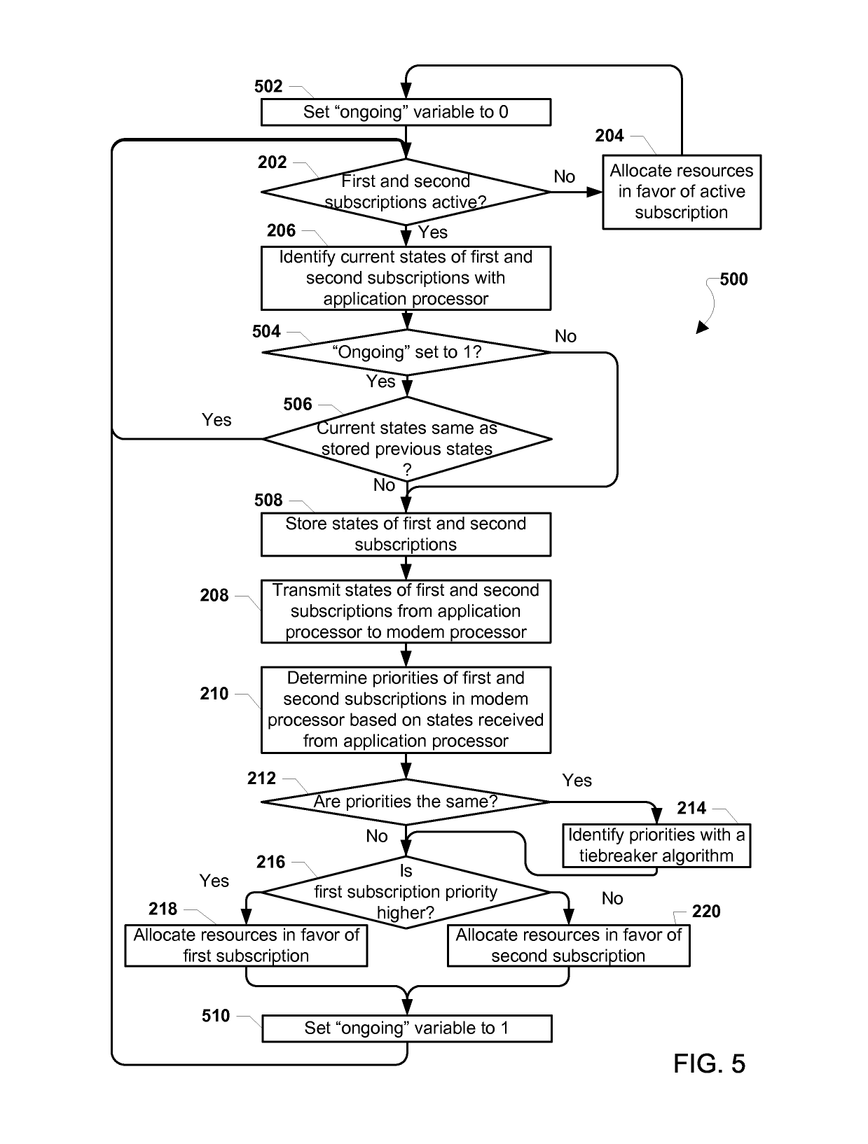

FIG. 5 illustrates another embodiment method 500 for a mobile device determining priorities of the concurrently active subscriptions. The method 500 is similar to the method 200 described above with reference to FIG. 2A, except that the method 500 may continually determine whether the states of subscriptions have changed and may only determine priorities when states have changed. In other words, instead of determining priorities of active subscriptions based on a predefined periodicity, priorities may be determined and resources management routines may be performed when events occur that cause subscription state changes. For example, the mobile device may determine priorities in response to determining that a first voice call on a first subscription has been placed on local-hold and a user is now actively conversing on a second voice call on a second subscription. Such events may include received signals, such as pages from third-party mobile devices (e.g., a page to initiate a telephonic call with a remote party, etc.), as well as received user inputs, such as graphical user interface inputs described above with reference to FIG. 2B.

In block 502, the mobile device may set an “ongoing” variable to zero. The “ongoing” variable may be a bit, flag, semaphore, system variable, or other stored information the mobile device may use to indicate when two subscriptions are concurrently active. The “ongoing” variable may be used by the mobile device to identify when stored previous states of active subscriptions should be compared to current states to detect when a change has occurred. In other words, when the “ongoing” variable is set to zero, the mobile device may not evaluate previous states of concurrently active subscriptions to determine whether a change in state has occurred.

In determination block 202, the mobile device may determine whether a first subscription and a second subscription are active. If the first and second subscriptions are not both active (i.e., determination block 202=“No”), in block 204 the mobile device may allocate resources in favor of the active subscription and may continue with the operations in block 502. However, if the first and second subscriptions are determined to be active (i.e., determination block 202=“Yes”), in block 206 the mobile device may identify the current states of the first and second subscriptions with the applications processor. In determination block 504, the mobile device may determine whether the “ongoing” variable is set to one. In other words, the mobile device may evaluate the “ongoing” variable value to determine whether there are stored previous states to compare to the identified current states for the concurrently active subscriptions.

If the “ongoing” variable is set to one (i.e., determination block 504=“Yes”), in determination block 506 the mobile device may determine whether the current states are the same as the stored previous states. In particular, the mobile device may determine whether the current identified state of the first subscription is the same as the stored previous state for the first subscription and whether the current identified state of the second subscription is the same as the stored previous state of the second subscription. The mobile device may compare stored previous states to current identified states to determine any differences, such as different codes, values, or other indicators that show the current and previous states to be different for either of the active subscriptions. For example, the mobile device may compare a stored previous state of “voice-high” with a current identified state of “data” to determine the states have changed for the first subscription. If the current states of both the first and second subscriptions are the same as the stored previous states (i.e., determination block 506=“Yes”), the mobile device may continue with the operations in determination block 202. For example, the first and second subscriptions may remain in the same states and thus no action to determine priorities may be required.

If the “ongoing” variable is not set to one (i.e., determination block 504=“No”) or if the current states are not the same as the stored previous states (i.e., determination block 506=“No”), in block 508 the mobile device may store the states of the first and second subscriptions. For example, the mobile device may store state indicators, such as codes, bits, or string values, within system variables, arrays, or other data structures. These stored states may be the previous states for subsequent executions of the operations in determination block 506.

In block 208, the mobile device may transmit the identified states of the first and second subscriptions from the applications processor to the modem processor. In block 210, the mobile device may determine priorities of the first and second subscriptions in the modem processor based on states received from the applications processor. In determination block 212, the mobile device may determine whether the first and second subscriptions' priorities are the same. If the priorities are the same (i.e., determination block 212=“Yes”), in block 214 the mobile device may identify priorities with a tiebreaker algorithm. If the priorities are not the same (i.e., determination block 212=“No”) or if priorities have been identified with the tiebreaker algorithms, in determination block 216 the mobile device may determine whether the first subscription priority is higher. If the first subscription has a higher priority (i.e., determination block 216=“Yes”), in block 218 the mobile device may allocate resources in favor of the first subscription. If the first subscription does not have a higher priority (i.e., determination block 216=“No”), in block 220 the mobile device may allocate resources in favor of the second subscription. In block 510, the mobile device may set the “ongoing” variable to one, and may continue with the operations in determination block 202.

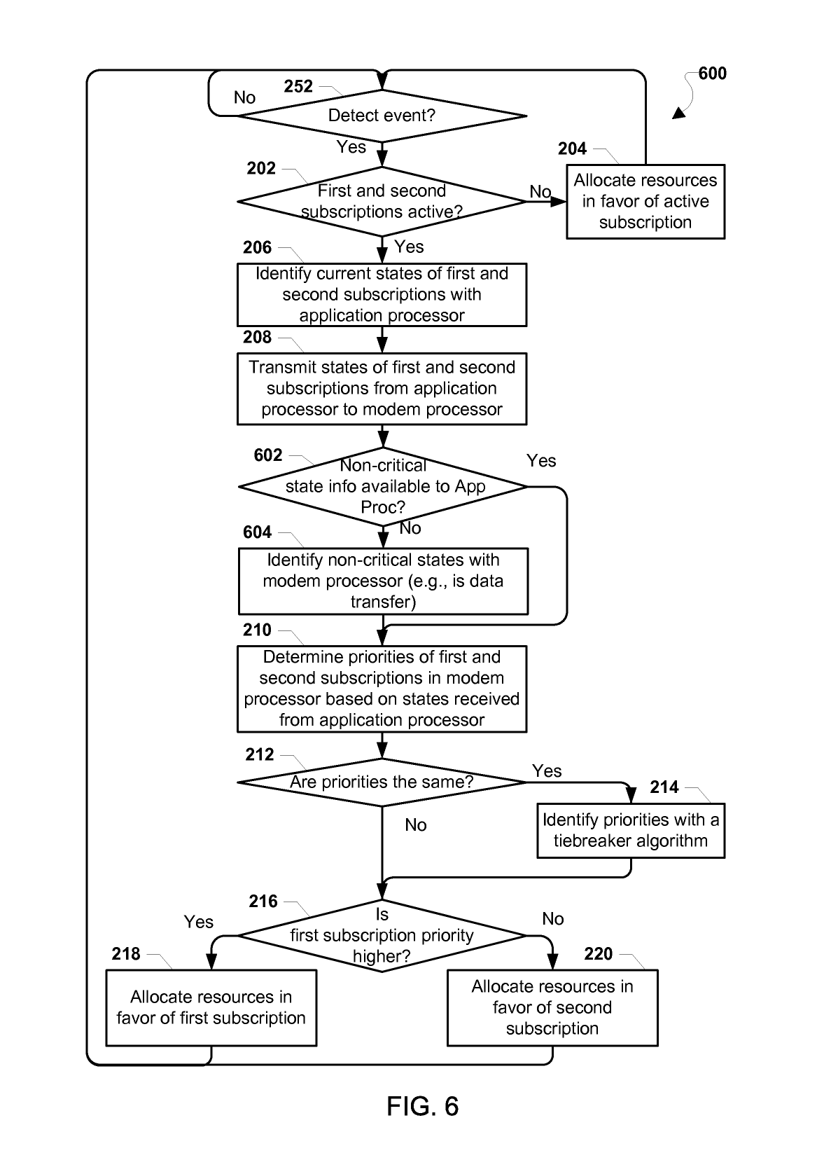

FIG. 6 illustrates an embodiment method 600 for a mobile device to determine priorities of the concurrently active subscriptions with missing non-critical state information. The method 600 may be similar to the method 250, except that the method 600 may include operations to enable a modem processor within the mobile device to identify subscription states when an applications processor within the mobile device does not identify these subscription states. In general, the applications processor (or the high-level operating system executing on the applications processor) may identify subscription states and provide the states to the modem processor for prioritizing. For example, the applications processor may inform the modem processor that a subscription is in a “voice-high”state. However, certain high-level operating systems and/or the applications processor may not have access to the same state information about the subscription that the modem processor does, such as subscription registrations. In such cases, the modem processor may be configured to piece together the state of the subscription based on information only available to the modem processor.

In particular, the applications processor and/or the high-level operating system may have information that describes “crucial” state information of the operations of concurrently active subscriptions. Crucial state information may include indicators of event occurrences, such as user inputs, button presses, use of a slider, ordering a list, etc., as well as other information that indicates whether subscriptions are active and/or exchanging information. For example, the high-level operating system may have access to data that indicates communications on a particular subscription is in a local-hold based on received user inputs (e.g., a “hold” graphical user interface button was pressed). As another example, the applications processor may be aware when a page has arrived at the mobile device. However, the applications processor and/or the high-level operating system may not be aware of “non-critical” state information that includes characteristics or attributes of information exchanged by concurrently active subscriptions. For example, the applications processor may have access to information that indicates whether the mobile device's user pressed a “accept” button to start a phone call, but may not have access to information that indicates whether the mobile device is transmitting data over a subscription. In an embodiment, the applications processor may inform the modem processor that a subscription is in a baseline state when non-critical state information is not available to the applications processor.

In determination block 252, the mobile device may determine whether an event is detected. If the mobile device does not detect an event (i.e., determination block 252=“No”), the mobile device may continue with the operations in determination block 252. If the mobile device detects an event (i.e., determination block 252=“Yes”), in determination block 202 the mobile device may determine whether a first subscription and a second subscription are active. If the first and second subscriptions are not both active (i.e., determination block 202=“No”), in block 204 the mobile device may allocate resources in favor of the active subscription and may continue with the operations in determination block 252. However, if the first and second subscriptions are determined to be active (i.e., determination block 202=“Yes”), in block 206 the mobile device may identify the current states of the first and second subscriptions with the applications processor. In block 208, the mobile device may transmit the identified states of the first and second subscriptions from the applications processor to the modem processor.

In determination block 602 the mobile device may determine whether non-critical state information was available to the applications processor. In other words, the mobile device may determine whether the applications processor was missing or did not have access to non-critical state information. As described above, non-critical state information may include information that indicates whether a subscription corresponds to a data transfer or data call. For example, the applications processor may or may not receive information from a subscription that indicates whether the subscription is actively involved in a transfer of data (e.g., a data download or upload). Conversely, critical state information may include information that indicates a subscription corresponds to a voice call. In an embodiment, the mobile device may determine non-critical data is missing or otherwise unavailable to the applications processor when the applications processor identifies a subscription is in a baseline state. If non-critical state information was not available to the applications processor (i.e., determination block 602=“No”), in block 604 the mobile device may identify non-critical states with the modem processor. For example, the modem processor may evaluate information from a subscription having an “unknown” or “baseline” state as identified by the applications processor, and may determine that the subscription corresponds to a data transfer (i.e., in a “data” state). In an embodiment, the modem processor may be configured to correct, modify, or otherwise adjust state identifications generated by the applications processor and/or high-level operating system. For example, the applications processor may identify a particular subscription as having a “voice-high” state, but based on information exchanged by in relation to the subscription, the modem processor may change the state to be a “data” state.

If non-critical state information was available to the applications processor (i.e., determination block 602=“Yes”), or the modem processor identified non-critical states in block 604, in block 210 the mobile device may determine priorities of the first and second subscriptions in the modem processor based on states received from the applications processor. In determination block 212, the mobile device may determine whether the first and second subscriptions' priorities are the same. If the priorities are the same (i.e., determination block 212=“Yes”), in block 214 the mobile device may identify priorities with a tiebreaker algorithm. If the priorities are not the same (i.e., determination block 212=“No”) or if priorities have been identified with the tiebreaker algorithms, in determination block 216 the mobile device may determine whether the first subscription priority is higher. If the first subscription has a higher priority (i.e., determination block 216=“Yes”), in block 218 the mobile device may allocate resources in favor of the first subscription and may continue with the operations in determination block 252. If the first subscription does not have a higher priority (i.e., determination block 216=“No”), in block 220 the mobile device may allocate resources in favor of the second subscription and may continue with the operations in determination block 252.

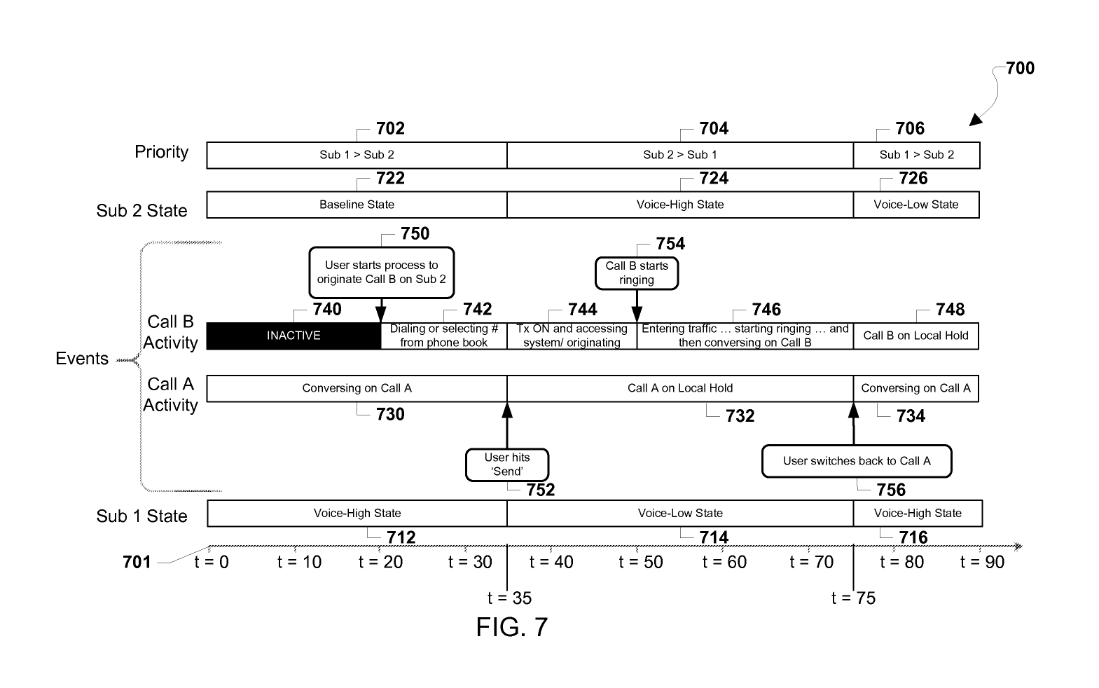

FIG. 7 is a diagram 700 that illustrates exemplary changes in priorities of two concurrently active subscriptions within an embodiment mobile device. The diagram 700 shows the priorities, states of a first subscription (referred to as “Sub 1”) and a second subscription (referred to as “Sub 2”), and activities of the mobile device over a period of time indicated by a timeline 701. For example, the period may begin at time 0 (i.e., “t=0” as shown in the FIG. 7) and may end at time 90 (i.e., “t=90”). Further, the values represented in the diagram 700, such as “Sub 1>Sub 2” or “Voice-High State” may be stored in the mobile device as variables, bits, or other indicators. For example, the mobile device may store the priority of the two subscriptions and the states of the two subscriptions as system variables and may modify those system variables over time. The diagram 700 also shows events that may occur during the period. For example, events may include detected user inputs on a graphical user interface of the mobile device. As another example, events may also include when the mobile device enters an operating routine, such as ringing or polling networks. The diagram 700 also shows activity descriptions of calls (referred to as “Call A” and “Call B”) corresponding to the two active subscriptions. “Call A” may be a call, such as a data transfer or a voice call, associated with the first subscription (or “Sub 1”), and “Call B” may be a call, such as a data transfer or a voice call, associated with the second subscription (or “Sub 2”). In particular, the activity descriptions may indicate whether the user is talking or conversing on a particular subscription at a given time, whether the user has placed a call on local-hold, and other actions, processes, or routines a mobile device may be performing at a given time with respect to communication technologies or subscriptions.

For the purposes of illustration: at time t=0, Sub 1 state block 712 may indicate Sub 1 is in “voice-high” state and Call A activity block 730 may indicate that the user is conversing on Call A (via Sub 1). Sub 2 state block 722 may indicate Sub 2 is in “baseline” state and Call B activity block 740 may indicate that Sub 2 is inactive. In other words, Call B may not be active and a transmitter associated with the Sub 2 may be deactivated or configured to be “OFF”. Thus, based on the “voice-high” and “baseline” state values, the mobile device may store a priority block 702 that indicates Sub 1 has higher priority than Sub 2 (i.e., “Sub 1>Sub 2”).

At time t=20, an event 750 may coincide with the mobile device's user starting the process to originate Call B on Sub 2. In response to the event 750, Call B activity block 742 may indicate that the mobile device (or the user) is dialing and/or selecting a number from a phone book stored in the mobile device, such as a phone number for a voice call. For example, the user may place Call A on Sub 1 on network-hold (i.e., a hold state that the cellular network is aware of) and begin browsing through a contact list to find information regarding a recipient for a voice call on Sub 2.

At time t=35, an event 752 may coincide with the mobile device detecting the user hitting “send” on the mobile device. For example, the “send” button may be a button on the housing of the mobile device or a graphical user interface button that is configured to cause a voice call to start. As a result, Sub 1 state block 714 may indicate Sub 1 is in “voice-low” state and Call A activity block 732 may indicate that Call A is on local-hold. For instance, the user may no longer be conversing on Call A. Sub 2 state block 724 may indicate Sub 2 is in “voice-high” state and Call B activity block 744 may indicate that a transmitter associated with Sub 2 (referred to in FIG. 7 as “Tx”) may be on (or activated) and accessing a system and/or originating. For example, the transmitter may be transmitting signals related to the origination of Call B and/or may be exchanging signals with a network. Thus, based on the “voice-high” state value of Sub 2 and the “voice-low” state value of Sub 1, the mobile device may store a priority block 704 that indicates Sub 2 has higher priority than Sub 1 (i.e., “Sub 2>Sub 1”). In another embodiment, if the Call B is not originated, the user may elect to go back to Call A on Sub 1.

At time t=50, an event 754 may coincide with Call B starting to ring. In other words, Call B may be a voice call that is waiting to be accepted by another person (e.g., the phone call recipient). In response to the event 754, Call B activity block 746 may indicate that the Sub 2 is entering traffic, the Call B is starting to ring, and the user is conversing on Call B.

At time t=75, an event 756 may coincide with the user switching back to Call A. For example, the mobile device may detect that the user pressed a “switch” graphical user interface button on the mobile device. As a result, Sub 1 state block 716 may indicate Sub 1 is in “voice-high” state and Call A activity block 734 may indicate that the user is once again conversing on Call A. Sub 2 state block 726 may indicate Sub 2 is in “voice-low” state and Call B activity block 748 may indicate that Call B is on local-hold. Thus, based on the “voice-high” state value of Sub 1 and the “voice-low” state value of Sub 2, the mobile device may store a priority block 706 that indicates Sub 1 has higher priority than Sub 2 (i.e., “Sub 1>Sub 2”).

It may be noted that for diagram 700 there may be no transient state in which both Sub 1 and Sub 2 are in the same voice state. In other words, only one subscription may be in the “voice-high” state at a given time. This may be attributed to the notion that voice calls may not be conversed upon simultaneously. However, in other embodiments, the user may have the same state for two simultaneous voice calls when participating in a group or conference call, in which case the mobile device may perform a tiebreaker algorithm to allocate resources.

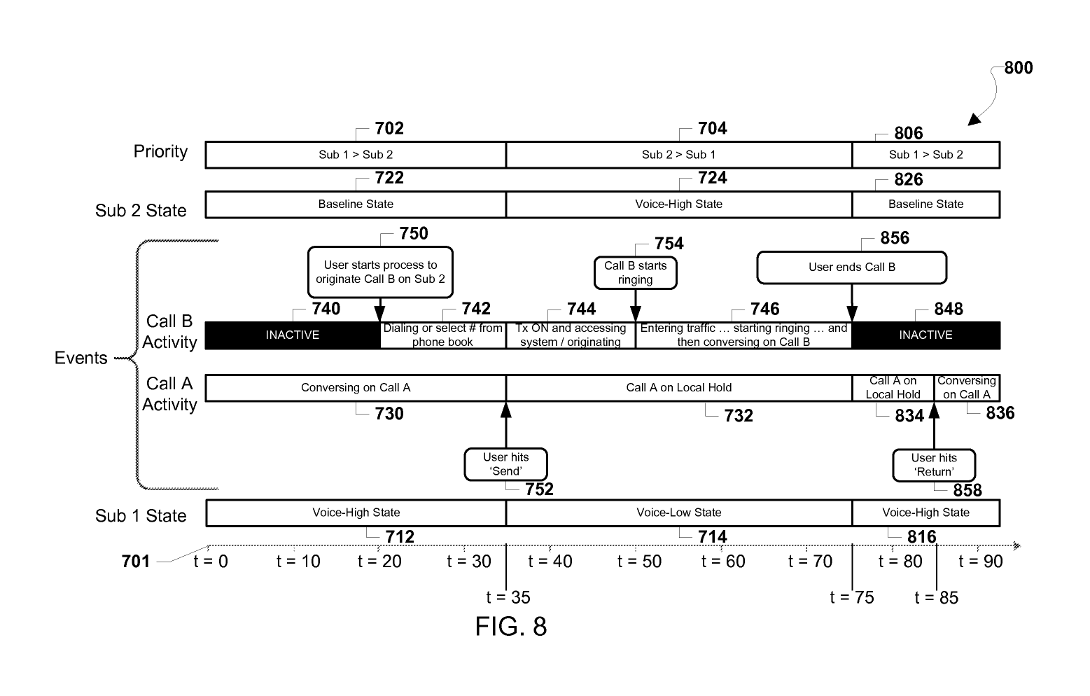

FIG. 8 is a diagram 800 that illustrates exemplary changes in priorities of two concurrently active subscriptions within another embodiment mobile device. The diagram 800 shows the priorities, states of a first subscription (referred to in FIG. 8 as “Sub 1”) and a second subscription (referred to in FIG. 8 as “Sub 2”), and activities of the mobile device over a period of time indicated by a timeline 701. The diagram 800 is similar to the diagram 700 described above, except that the diagram 800 shows events coinciding with the mobile device's user ending a call instead of switching between two active voice calls. The diagram 800 is valuable for illustrating that a state of a subscription associated with a voice call may be “voice-high” even when the related voice call is configured to be on local-hold.

For the purposes of illustration: at time t=0, Sub 1 state block 712 may indicate Sub 1 is in “voice-high” state and Call A activity block 730 may indicate that the user is conversing on Call A (via Sub 1). Sub 2 state block 722 may indicate Sub 2 is in “baseline” state and Call B activity block 740 may indicate that the second subscription is inactive. Thus, based on the “voice-high” and “baseline” state values, the mobile device may store a priority block 702 that indicates Sub 1 has higher priority than Sub 2 (i.e., “Sub 1>Sub 2”).

At time t=20, an event 750 may coincide with the mobile device (or the device's user) starting the process to originate Call B on Sub 2. In response to the event 750, Call B activity block 742 may indicate that, with respect to Sub 2, the mobile device is dialing and/or selecting a number from a phone book, such as a phone number for a voice call that is stored in the mobile device.

At time t=35, an event 752 may coincide with the mobile device detecting the user hit “send” on the mobile device. For example, the “send” button may be a button on the housing of the mobile device or a graphical user interface button that is configured to cause a voice call to start. As a result, Sub 1 state block 714 may indicate Sub 1 is in “voice-low” state and Call A activity block 732 may indicate that Call A is on local-hold. In other words, the user is no longer conversing on Call A. Sub 2 state block 724 may indicate Sub 2 is in “voice-high” state and Call B activity block 744 may indicate that the transmitter associated with Sub 2 (referred to in FIG. 8 as “Tx”) may be on (or activated) and accessing a system and/or originating. For example, the transmitter may be transmitting signals related to the origination of Call B and/or may be exchanging signals with a network. Thus, based on the “voice-high” state value of Sub 2 and the “voice-low” state value of Sub 1, the mobile device may store a priority block 704 that indicates Sub 2 has higher priority than Sub 1 (i.e., “Sub 2>Sub 1”). In another embodiment, if the Call B is not originated, the user may elect to go back to Call A on Sub 1.

At time t=50, an event 754 may coincide with Call B starting to ring on Sub 2. In other words, Call B may be a voice call that is waiting to be accepted by another person (e.g., the phone call recipient). In response to the event 754, Call B activity block 746 may indicate that the Sub 2 is entering traffic, the Call B is starting to ring, and the user is conversing on Call B on Sub 2.

At time t=75, an event 856 may coincide with the user ending Call B. For example, the mobile device may detect the user pressed an “end” graphical user interface button on the mobile device that causes communications to cease on Sub 2. As a result, Sub 1 state block 816 may indicate Sub 1 is in “voice-high” state. However, since there was no switch, the Call A activity block 834 may still indicate that Call A is on local-hold. For example, the user may end Call B without desiring to immediately start conversing on Call A again. In other words, because Call B may have ended, Call A may be the only call remaining, and thus Sub 1 may be in “voice-high” state regardless of whether or not the user immediately resumes conversing on Call A. Sub 2 state block 826 may indicate Sub 2 is in “baseline” state and Call B activity block 848 may indicate that Call B is inactive. Thus, based on the “voice-high” state value of Sub 1 and the “baseline” state value of Sub 2, the mobile device may store a priority block 806 that indicates Sub 1 has higher priority than Sub 2 (i.e., “Sub 1>Sub 2”).

At time t=85, an event 858 may coincide with the mobile device detecting the user hit “return.” In other words, the user of the mobile device may want to start conversing on Call A on Sub 1 again after a period of deciding what to do. Alternatively, the user may have decided to start another call on Sub 2. In response to the event 858, Call A activity block 836 may indicate that the Sub 1 is being used and the user is conversing on Call A. Regardless of whether the user began conversing on Call A again or the user hitting “return,” Sub 1 may be in the “voice-high” state as the only active voice call in the mobile device after time t=75.

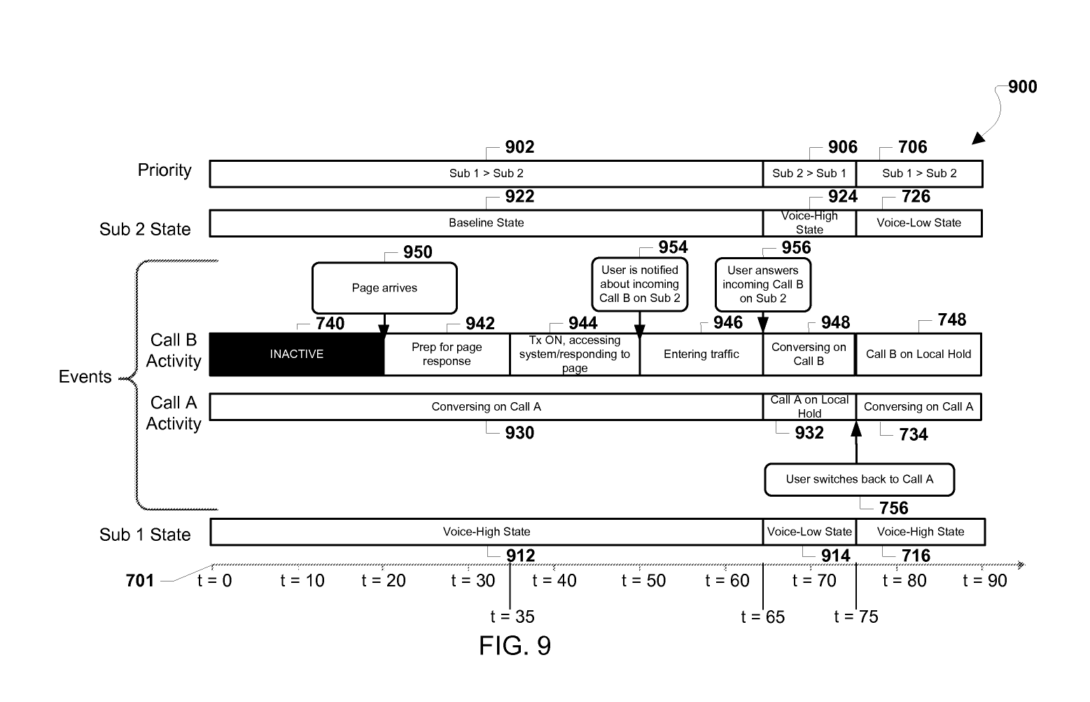

FIG. 9 is a diagram 900 that illustrates exemplary changes in priorities of two concurrently active subscriptions within an embodiment mobile device. The diagram 900 shows the priorities, states of a first subscription (referred to in FIG. 8 as “Sub 1”) and a second subscription (referred to in FIG. 8 as “Sub 2”), and activities of the mobile device over a period of time indicated by a timeline 701. The diagram 900 is similar to the diagram 700 described above, except that Sub 2 may be configured to receive pages and may be in a “voice-high” state only when the user answers an incoming message (or voice call) subsequent to receiving a page. In other words, the mobile device may not reallocate resources away from a voice call that the user originated to benefit a subscription associated with a voice call the user did not originate until the user switches (or answers) the non-originated voice call.

For the purposes of illustration: at time t=0, Sub 1 state block 912 may indicate Sub 1 is in “voice-high” state and Call A activity block 930 may indicate that the user is conversing on Call A (via Sub 1). Sub 2 state block 922 may indicate Sub 2 is in “baseline” state and Call B activity block 740 may indicate that the Sub 2 is inactive. In other words, Call B may not be active and a transmitter associated with the Sub 2 may be deactivated or configured to be “OFF”. In an embodiment, the “baseline” state of Sub 2 may also indicate the deactivated nature of the transmitter. For example, at time t=0 Sub 2 may have the state of “baseline with transmitter OFF.” Thus, based on the “voice-high” and “baseline” state values, the mobile device may store a priority block 902 that indicates Sub 1 has higher priority than Sub 2 (i.e., “Sub 1>Sub 2”).

At time t=20, an event 950 may coincide with a page arriving at the mobile device. For example, a remote party's mobile device may transmit a page request to the mobile device indicating an invitation to participate in a telephonic voice call. In response, Call B activity block 942 may indicate that the mobile device is preparing for a page response on Sub 2, such as answering an invitation for a voice call on Sub 2.

At time t=35, Call B activity block 944 may indicate that the transmitter associated with Sub 2 (referred to in FIG. 9 as “Tx”) may be on (or activated) and accessing a system and/or responding to the page. For example, the transmitter may transmit signals in response to receiving the page related to Call B on Sub 2. However, the state value of both Sub 1 and Sub 2 may not change at this time, as the user may still be conversing on Call A related to Sub 1 and Sub 2 may still not be an active voice call nor a data transfer/call. In other words, a transmitter associated with Sub 2 may be activated or configured to be “ON” but the user may not yet converse on Call B on Sub 2. In an embodiment, the “baseline” state of Sub 2 may also indicate the activated nature of the transmitter. For example, at time t=35, Sub 2 may have the state of “baseline with transmitter ON.”

At time t=50, an event 954 may coincide with the mobile device notifying the user about the incoming Call B on Sub 2. For example, the mobile device may start to ring indicating Call B may be answered (or rejected). In response to the event 954, Call B activity block 946 may indicate that the Sub 2 is entering traffic.

At time t=65, an event 956 may coincide with the user answering the incoming Call B on Sub 2. In response to the event 956, Call B activity block 948 may indicate that the user is conversing on Call B. As a result, Sub 2 state block 924 may indicate Sub 2 is in “voice-high” state. Sub 1 state block 914 may indicate Sub 1 is in “voice-low” state and Call A activity block 932 may indicate that Call A is on local-hold. Thus, based on the “voice-high” state value of Sub 2 and the “voice-low” state value of Sub 1, the mobile device may store a priority block 906 that indicates Sub 2 has higher priority than Sub 1 (i.e., “Sub 2>Sub 1”).

At time t=75, an event 756 may coincide with the mobile device detecting that the user switched back to Call A on Sub 1. For example, the user may press a “switch” graphical user interface button on the mobile device. As a result, Sub 1 state block 716 may indicate Sub 1 is in “voice-high” state and Call A activity block 734 may indicate that the user is once again conversing on Call A. Sub 2 state block 726 may indicate Sub 2 is in “voice-low” state and Call B activity block 748 may indicate that Call B is on local-hold. Thus, based on the “voice-high” state value of Sub 1 and the “voice-low” state value of Sub 2, the mobile device may store a priority block 706 that indicates Sub 1 has higher priority than Sub 2 (i.e., “Sub 1>Sub 2”).

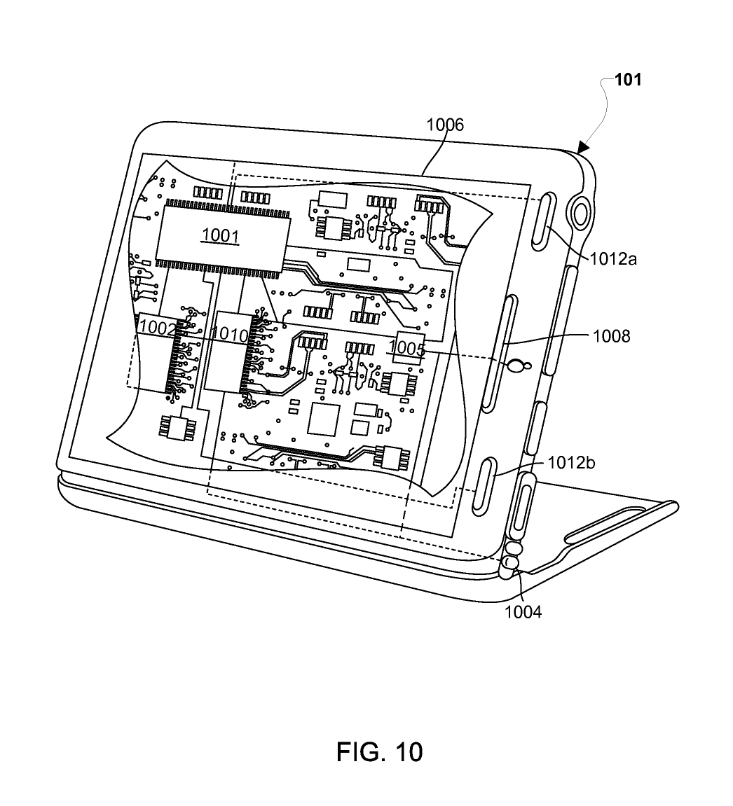

FIG. 10 is a system block diagram of a mobile device 101 suitable for use with any of the embodiments. A typical mobile device 101 may include a processor 1001, such as an applications processor, coupled to internal memory 1002, a display 1006, and a speaker 1008. Additionally, the mobile device 101 may include a modem processor 1010 coupled to memory 1002 and the processor 1001. Additionally, the mobile device may include an antenna 1004 for sending and receiving electromagnetic radiation. The antenna 1004 may be connected to a wireless data link and/or cellular telephone transceiver 1005 coupled to the processor 1001 and/or the modem processor 1010. In an embodiment, the mobile device 101 may include a second antenna (not shown) for sending and receiving electromagnetic radiation. The second antenna may be connected to a wireless data link and/or cellular telephone transceiver 1005 coupled to the processor 1001. In an embodiment, a mobile multimedia broadcast receiver (not shown) may be coupled to the processor 1001. Mobile devices 101 typically also include menu selection buttons 1012a, 1012b (or rocker switches) for receiving user inputs.

The processors 1001, 1010 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 1002 before they are accessed and loaded into the processor 1001. The processors 1001, 1010 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1001, 1010 including internal memory or removable memory plugged into the device and memory within the processors 1001, 1010.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be implemented as one or more processor-executable instructions or code stored on a processor-readable storage medium. The operations of a method or algorithm disclosed herein may be embodied in a processor-executable software module that may be stored on a tangible, non-transitory processor-readable storage medium. Tangible, non-transitory processor-readable storage media may be any available media that may be accessed by a processor of a computer or computing device. By way of example, and not limitation, such non-transitory processor-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory processor-readable storage media. Additionally, the operations of a method or algorithm may reside as one or any combination or set of codes and/or instructions on a tangible, non-transitory machine readable medium and/or processor-readable medium that may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for prioritizing subscriptions to allocate device resources in a mobile device employing a dual subscription, dual active configuration, the method comprising:
determining whether a first subscription and a second subscription are concurrently active;
identifying a first state related to the first subscription and a second state related to the second subscription in response to determining that the first subscription and the second subscription are concurrently active;
determining a first priority of the first subscription based on the first state and a second priority of the second subscription based on the second state;
allocating device resources in favor of the first subscription when the first priority is higher than the second priority; and
allocating the device resources in favor of the second subscription when the second priority is higher than the first priority.

2. The method of claim 1, wherein determining whether the first subscription and the second subscription are concurrently active is periodically performed in response to a predefined time elapsing.

3. The method of claim 1, wherein determining whether the first subscription and the second subscription are concurrently active is periodically performed in response to detecting an event, wherein the event may include at least one of receiving a user input, receiving a page, receiving signals on a channel, and losing connectivity.

4. The method of claim 1, wherein identifying the first state of the first subscription and the second state of the second subscription is performed by an applications processor, and determining the first priority of the first subscription based on the first state and the second priority of the second subscription based on the second state is performed by a modem processor.

5. The method of claim 1, further comprising identifying at least one of the first state of the first subscription and the second state of the second subscription by a modem processor in response to determining non-critical state information is not available to an applications processor.

6. The method of claim 1, wherein identifying a first state of the first subscription and a second state of the second subscription comprises:
identifying either the first state or the second state as being in a voice-high state when related state information corresponds to a voice call not on local-hold or an origination for a voice call;
identifying either the first state or the second state as being in a voice-low state when related state information corresponds to a voice call on local-hold;
identifying either the first state or the second state as being in a data state when related state information corresponds to a data transfer or an origination for a data transfer; and
identifying either the first state or the second state as being in a baseline state when related state information does not correspond to the voice-high state, the voice-low state, or the data state.

7. The method of claim 1, wherein device resources include at least one of emitted radiation management, radio frequency coexistent management, allocation of processing resources, battery power, and thermal mitigation.

8. The method of claim 1, wherein allocating device resources comprises allocating battery current.

9. The method of claim 1, wherein allocating device resources comprises allocating an antenna with a best reception.

10. The method of claim 1, wherein device resources include transmit power.

11. The method of claim 1, wherein device resources include at least one of throttling and transmit (Tx) blanking.

12. The method of claim 1, further comprising identifying new priorities for the first subscription and the second subscription when the determined first priority is the same as the determined second priority using a tiebreaker algorithm.

13. The method of claim 12, wherein using the tiebreaker algorithm comprises determining whether the first subscription and the second subscription correspond to at least one of a wireless wide area, a wireless local area network, delay sensitive data, a short-range radio signal, global positioning system data, an origination event by a user, and default subscription indicators.

14. The method of claim 1, wherein the first subscription and the second subscription include at least one of WWAN or WLAN technologies.

15. The method of claim 14, wherein the first subscription and the second subscription are associated with different technologies.

16. A mobile device configured to prioritize concurrently active subscriptions to allocate device resources in a dual subscription, dual active configuration, comprising:
means for determining whether a first subscription and a second subscription are concurrently active;
means for identifying a first state related to the first subscription and a second state related to the second subscription in response to determining that the first subscription and the second subscription are concurrently active;
means for determining a first priority of the first subscription based on the first state and a second priority of the second subscription based on the second state;
means for allocating device resources in favor of the first subscription when the first priority is higher than the second priority; and
means for allocating the device resources in favor of the second subscription when the second priority is higher than the first priority.

17. The mobile device of claim 16, wherein means for determining whether the first subscription and the second subscription are concurrently active is periodically performed in response to a predefined time elapsing.

18. The mobile device of claim 16, wherein means for determining whether the first subscription and the second subscription are concurrently active is periodically performed in response to detecting an event, wherein the event may include at least one of receiving a user input, receiving a page, receiving signals on a channel, and losing connectivity.

19. The mobile device of claim 16, wherein means for identifying the first state of the first subscription and the second state of the second subscription is performed by an applications processor, and determining the first priority of the first subscription based on the first state and the second priority of the second subscription based on the second state is performed by a modem processor.

20. The mobile device of claim 16, further comprising means for identifying at least one of the first state of the first subscription and the second state of the second subscription by a modem processor in response to determining non-critical state information is not available to an applications processor.

21. The mobile device of claim 16, wherein means for identifying a first state of the first subscription and a second state of the second subscription comprises:
means for identifying either the first state or the second state as being in a voice-high state when related state information corresponds to a voice call not on local-hold or an origination for a voice call;
means for identifying either the first state or the second state as being in a voice-low state when related state information corresponds to a voice call on local-hold;
means for identifying either the first state or the second state as being in a data state when related state information corresponds to a data transfer or an origination for a data transfer; and
means for identifying either the first state or the second state as being in a baseline state when related state information does not correspond to the voice-high state, the voice-low state, or the data state.

22. The mobile device of claim 16, wherein device resources include at least one of emitted radiation management, radio frequency coexistent management, allocation of processing resources, battery power, and thermal mitigation.

23. The mobile device of claim 16, wherein means for allocating device resources comprises means for allocating battery current.

24. The mobile device of claim 16, wherein means for allocating device resources comprises means for allocating an antenna with a best reception.

25. The mobile device of claim 16, wherein device resources include transmit power.

26. The mobile device of claim 16, wherein device resources include at least one of throttling and transmit (Tx) blanking.

27. The mobile device of claim 16, further comprising means for identifying new priorities for the first subscription and the second subscription when the determined first priority is the same as the determined second priority using a tiebreaker algorithm.

28. The mobile device of claim 27, wherein the tiebreaker algorithm includes means for determining whether the first subscription and the second subscription correspond to at least one of a wireless wide area, a wireless local area network, delay sensitive data, a short-range radio signal, global positioning system data, an origination event by a user, and default subscription indicators.

29. The mobile device of claim 16, wherein the first subscription and the second subscription include at least one of WWAN or WLAN technologies.

30. The mobile device of claim 29, wherein the first subscription and the second subscription are associated with different technologies.

31. A mobile device configured to prioritize concurrently active subscriptions to allocate resources in a dual subscription, dual active configuration, comprising:
a memory; and
a first processor coupled to the memory, wherein the first processor is configured with processor-executable instructions to perform operations comprising:
determining whether a first subscription and a second subscription are concurrently active;
identifying a first state related to the first subscription and a second state related to the second subscription in response to determining that the first subscription and the second subscription are concurrently active;
determining a first priority of the first subscription based on the first state and a second priority of the second subscription based on the second state;
allocating device resources in favor of the first subscription when the first priority is higher than the second priority; and
allocating the device resources in favor of the second subscription when the second priority is higher than the first priority.

32. The mobile device of claim 31, wherein the first processor is configured with processor-executable instructions to perform operations such that determining whether the first subscription and the second subscription are concurrently active is periodically performed in response to a predefined time elapsing.

33. The mobile device of claim 31, wherein the first processor is configured with processor-executable instructions to perform operations such that determining whether the first subscription and the second subscription are concurrently active is periodically performed in response to detecting an event, wherein the event may include at least one of receiving a user input, receiving a page, receiving signals on a channel, and losing connectivity.

34. The mobile device of claim 31, further comprising:
a second processor coupled to the memory and the first processor,
wherein the second processor is configured with processor-executable instructions to perform operations comprising determining the first priority of the first subscription based on the first state and the second priority of the second subscription based on the second state, and
wherein the second processor is a modem processor, and
wherein the first processor is an applications processor.

35. The mobile device of claim 31, further comprising:
a second processor coupled to the memory and the first processor, wherein the second processor is configured with processor-executable instructions to perform operations comprising identifying at least one of the first state of the first subscription and the second state of the second subscription when non-critical state information is not available to the first processor, and
wherein the second processor is a modem processor,
wherein the first processor is an applications processor.

36. The mobile device of claim 31, wherein the first processor is configured with processor-executable instructions to perform operations such that identifying a first state of the first subscription and a second state of the second subscription comprises:
identifying either the first state or the second state as being in a voice-high state when related state information corresponds to a voice call not on local-hold or an origination for a voice call;
identifying either the first state or the second state as being in a voice-low state when related state information corresponds to a voice call on local-hold;
identifying either the first state or the second state as being in a data state when related state information corresponds to a data transfer or an origination for a data transfer; and
identifying either the first state or the second state as being in a baseline state when related state information does not correspond to the voice-high state, the voice-low state, or the data state.

37. The mobile device of claim 31, wherein device resources include at least one of emitted radiation management, radio frequency coexistent management, allocation of processing resources, battery power, and thermal mitigation.

38. The mobile device of claim 31, wherein the first processor is configured with processor-executable instructions to perform operations such that allocating device resources comprises allocating battery current.

39. The mobile device of claim 31, wherein the first processor is configured with processor-executable instructions to perform operations such that allocating device resources comprises allocating an antenna with a best reception.

40. The mobile device of claim 31, wherein device resources include transmit power.

41. The mobile device of claim 31, wherein device resources include at least one of throttling and transmit (Tx) blanking.

42. The mobile device of claim 31, wherein the first processor is configured with processor-executable instructions to perform operations further comprising identifying new priorities for the first subscription and the second subscription when the determined first priority is the same as the determined second priority using a tiebreaker algorithm.

43. The mobile device of claim 42, wherein the tiebreaker algorithm includes processor-executable instructions to perform operations for determining whether the first subscription and the second subscription correspond to at least one of a wireless wide area, a wireless local area network, delay sensitive data, a short-range radio signal, global positioning system data, an origination event by a user, and default subscription indicators.

44. The mobile device of claim 31, wherein the first subscription and the second subscription include at least one of WWAN or WLAN technologies.

45. The mobile device of claim 44, wherein the first subscription and the second subscription are associated with different technologies.

46. A non-transitory processor-readable storage medium having stored thereon processor-executable software instructions configured to cause a first processor to perform operations for prioritizing subscriptions to allocate resources in a mobile device employing a dual subscription, dual active configuration, the operations comprising:
determining whether a first subscription and a second subscription are concurrently active;
identifying a first state related to the first subscription and a second state related to the second subscription in response to determining that the first subscription and the second subscription are concurrently active;
determining a first priority of the first subscription based on the first state and a second priority of the second subscription based on the second state;
allocating device resources in favor of the first subscription when the first priority is higher than the second priority; and
allocating the device resources in favor of the second subscription when the second priority is higher than the first priority.

47. The non-transitory processor-readable storage medium of claim 46, wherein the stored processor-executable software instructions are configured to cause the first processor to perform operations such that determining whether the first subscription and the second subscription are concurrently active is periodically performed in response to a predefined time elapsing.

48. The non-transitory processor-readable storage medium of claim 46, wherein the stored processor-executable software instructions are configured to cause the first processor to perform operations such that determining whether the first subscription and the second subscription are concurrently active is periodically performed in response to detecting an event, wherein the event may include at least one of receiving a user input, receiving a page, receiving signals on a channel, and losing connectivity.

49. The non-transitory processor-readable storage medium of claim 46, wherein the stored processor-executable software instructions are configured to cause a second processor to perform operations comprising determining the first priority of the first subscription based on the first state and the second priority of the second subscription based on the second state, and wherein the second processor is a modem processor, and wherein the first processor is an applications processor.

50. The non-transitory processor-readable storage medium of claim 46, wherein the stored processor-executable software instructions are configured to cause a second processor to perform operations comprising identifying at least one of the first state of the first subscription and the second state of the second subscription when non-critical state information is not available to the first processor, wherein the second processor is a modem processor, and wherein the first processor is an applications processor.

51. The non-transitory processor-readable storage medium of claim 46, wherein the stored processor-executable software instructions are configured to cause the first processor to perform operations such that identifying a first state of the first subscription and a second state of the second subscription comprises:
identifying either the first state or the second state as being in a voice-high state when related state information corresponds to a voice call not on local-hold or an origination for a voice call;
identifying either the first state or the second state as being in a voice-low state when related state information corresponds to a voice call on local-hold;
identifying either the first state or the second state as being in a data state when related state information corresponds to a data transfer or an origination for a data transfer; and
identifying either the first state or the second state as being in a baseline state when related state information does not correspond to the voice-high state, the voice-low state, or the data state.

52. The non-transitory processor-readable storage medium of claim 46, wherein device resources include at least one of emitted radiation management, radio frequency coexistent management, allocation of processing resources, battery power, and thermal mitigation.

53. The non-transitory processor-readable storage medium of claim 46, wherein the stored processor-executable software instructions are configured to cause the first processor to perform operations such that allocating device resources comprises allocating battery current.

54. The non-transitory processor-readable storage medium of claim 46, wherein the stored processor-executable software instructions are configured to cause the first processor to perform operations such that allocating device resources comprises allocating an antenna with a best reception.

55. The non-transitory processor-readable storage medium of claim 46, wherein device resources include transmit power.

56. The non-transitory processor-readable storage medium of claim 46, wherein device resources include at least one of throttling and transmit (Tx) blanking.

57. The non-transitory processor-readable storage medium of claim 46, wherein the stored processor-executable software instructions are configured to cause the first processor to perform operations further comprising identifying new priorities for the first subscription and the second subscription when the determined first priority is the same as the determined second priority using a tiebreaker algorithm.

58. The non-transitory processor-readable storage medium of claim 57, wherein the stored processor-executable software instructions are configured to cause the first processor to perform operations to perform the tiebreaker algorithm comprising determining whether the first subscription and the second subscription correspond to at least one of a wireless wide area, a wireless local area network, delay sensitive data, a short-range radio signal, global positioning system data, an origination event by a user, and default subscription indicators.

59. The non-transitory processor-readable storage medium of claim 46, wherein the first subscription and the second subscription include at least one of WWAN or WLAN technologies.

60. The non-transitory processor-readable storage medium of claim 59, wherein the first subscription and the second subscription are associated with different technologies.
